(19) United States
(12) Patent Application Publication
(10) Pub. No.: US 2025/0164261 A1
(43) Pub. Date: May 22, 2025

(54) REAL-TIME TRAFFIC MANAGEMENT OF TRAFFIC AND TRAFFIC-LIGHT PATTERNS

(71) Applicant: Lyt, Inc., Santa Clara, CA (US)

(72) Inventors: Timothy Menard, Santa Clara, CA (US); Dustin Harber, Santa Clara, CA (US); Shmuel Silverman, Novato, CA (US)

(73) Assignee: Lyt, Inc., Santa Clara, CA (US)

(21) Appl. No.: 18/953,076

(22) Filed: Nov. 20, 2024

Related U.S. Application Data
(60) Provisional application No. 63/601,218, filed on Nov. 20, 2023.

(51) Int. Cl. G01C 21/34; G01C 21/36

(52) U.S. Cl. CPC G01C 21/3492; G01C 21/3415; G01C 21/3691

(57) ABSTRACT

A computer system that coordinates traffic management is described. During operation, the computer system may receive information from a traffic-management system of an environment and second information from at least an instance of traffic-mapping software associated with an electronic device of a user, where the information specifies the traffic-light patterns in a time interval. Then, the computer system may compute a route, for at least a vehicle associated with the user from a current location associated with the electronic device to a destination based at least in part on the information and the second information. Next, the computer system may provide instructions addressed to the electronic device, where the one or more instructions specify the computed route.

### CROSS REFERENCE TO RELATED APPLICATIONS

This application claims priority under 35 U.S.C. 119(e) to U.S. Provisional Application Ser. No. 63/601,218, “Real-Time Traffic Management of Traffic and Traffic-Light Patterns,” filed on Nov. 20, 2023, by Timothy Menard, et al., the contents of which are herein incorporated by reference.

### FIELD

The described embodiments relate generally to techniques for dynamic management of traffic and traffic-light patterns in an environment based at least in part on information associated with traffic-mapping software and second information associated with a traffic-management system of the environment (such as a municipality).

### BACKGROUND

Traffic management is often fragmented. For example, an existing approach to traffic management is provided by instances of traffic-mapping software (which is sometimes referred to as ‘navigation software’) installed on mobile electronic devices, which interact with a cloud-based server that computes and provides traffic-mapping information to the instances of the traffic-mapping software. A given instance of the traffic-mapping software typically provides instructions to a user (such as driving directions associated with a route, an estimated time of arrival, etc.). Often the driving directions are displayed on an interactive map on the mobile electronic device. Using the instance of the traffic mapping software, the user may be alerted to an event along a planned route (such as an accident, traffic or another type of delay). Moreover, when such an event occurs, the traffic-mapping software may provide one or more alternative routes to the user.

However, different instances of the traffic-mapping software that are installed on different mobile electronic devices associated with different users may present the same alternative route. Consequently, different vehicles may end up using the same route. This overlap may eliminate any time-of-arrival advantages associated with the route. Indeed, as a consequence at least some of the users may choose to revert to the original route. Therefore, the lack of coordination may result in confusion, delays, increased traffic and user frustration.

Moreover, existing traffic-mapping software may divert traffic onto secondary streets that are not designed to handle the resulting traffic load. In the process, traffic may be routed through a school zone or near a hospital, which may block Emergency Medical System (EMS) traffic, and which may increase the overall traffic load, delays and risks.

### SUMMARY

In a first group of embodiments, a computer system that coordinates traffic management is described. This computer system may include: an interface circuit that communicates with electronic devices (which may be remotely located from the computer system); a processor; and memory that stores program instructions and a data structure. During operation, the computer system receives information from a traffic-management system of an environment and second information from at least an instance of traffic-mapping software associated with an electronic device of a user. Then, the computer system computes a route, for at least a vehicle associated with the user from a current location associated with the electronic device to a destination based at least in part on the information and the second information. Next, the computer system provides instructions addressed to the electronic device, where the one or more instructions specify the computed route.

Note that the information may include traffic conditions in the environment (such as traffic flows), where the information is associated with different types of data sources distributed in the environment, and the environment includes multiple intersections and roadways.

Moreover, the second information may include a location of the electronic device.

Furthermore, the computer system may identify an event in at least a portion of the environment based at least in part on the information and/or the second information. Furthermore, the computer system may perform a remedial action based at least in part on the identified event. For example, the remedial action may include: dynamically recomputing the route based at least in part on the identified event; or providing an alert about the event (e.g., to the user). In some embodiments, identifying the event may be based at least in part on historical traffic conditions in the environment.

Additionally, identifying the event may include predicting a change in a traffic condition in the environment in a subsequent time interval. Alternatively or additionally, identifying the event may include determining a change in the traffic conditions after the change has occurred. In some embodiments, identifying the event may include comparing the traffic conditions to predefined signatures of different types of events. Note that identifying the event may be based at least in part on a pretrained predictive model, such as a machine-learning model or a neural network.

Note that the environment may include at least a portion of a city or a municipality.

Moreover, at least some of the information may include real-time information, such as information that is received as it is acquired by a given type of source.

Furthermore, receiving the information may include accessing the information in memory associated with the computer system and/or receiving the information from the different types of sources.

Additionally, the event may or may not be other than a traffic event and may impact the traffic conditions. For example, the event may include one or more of: a sporting event, an entertainment event, a weather condition, an accident, etc.

In some embodiments, the types of data sources may include data associated with one or more of: EMS (such as EMS vehicles), municipal or private vehicles (such as EMS vehicles, waste-removal vehicles, public-works vehicles, vehicles associated with another municipal agency, etc.), navigation software, mass transit systems (such as mass-transit vehicles, trains, buses, etc.), rideshare software or rideshare vehicles, calendar software (such as the planned or future schedules of one or more individuals or organizations), parking meters, parking lots, etc.

Note that the computed route may be based on transit times of multiple vehicles that are proximate to the vehicle in the environment. For example, the computed route may minimize transit times of the vehicle and the vehicles to destinations. Alternatively or additionally, the computed route may minimize transit times of second vehicles having a higher priority than the vehicle in the environment (such as EMS vehicles, municipal vehicles, mass-transit vehicles, waste-removal vehicles, public-works vehicles, vehicles associated with another municipal agency, etc.). In some embodiments, the proximate vehicles may be located in a same region in the environment as the vehicle.

Another embodiment provides a computer-readable storage medium for use with the computer system. When executed by the computer system, this computer-readable storage medium causes the computer system to perform at least some of the aforementioned operations.

Another embodiment provides a method that may be performed by the computer system. This method includes at least some of the aforementioned operations.

In a second group of embodiments, a computer system that manages traffic and traffic-light patterns is described. This computer system may include: an interface circuit that communicates with electronic devices (which may be remotely located from the computer system); a processor; and memory that stores program instructions and a data structure. During operation, the computer system receives information from a traffic-management system of an environment and second information from at least an instance of traffic-mapping software associated with an electronic device of a user, where the information specifies the traffic-light patterns in a time interval. Then, the computer system computes a route, for at least a vehicle associated with the user from a current location associated with the electronic device to a destination based at least in part on the information and the second information. Next, the computer system provides instructions addressed to the electronic device, where the one or more instructions specify the computed route.

Note that the route may be based at least in part on a predefined transportation goal. For example, the predefined transportation goal may include: pollution associated with the vehicle when navigating the route, energy consumption associated with the vehicle when navigating the route, travel time of the vehicle when navigating the route, battery life of a battery in the vehicle, and/or an idle time of the vehicle when navigating the route.

Moreover, in some embodiments, the computer system may provide, addressed to the traffic-management system, second instructions based at least in part on the route, where the second instructions include a change to at least one of the traffic-light patterns in a second time interval, and the second time interval is subsequent to the time interval.

Furthermore, a given traffic-light pattern in the traffic-light patterns may include states of the given traffic light and associated time durations, such as a duration of a green light, a duration of a yellow light, and a duration of a red light. Therefore, the given traffic-light pattern may specify when traffic is allowed to flow on particular roads in the environment.

Additionally, the information may include traffic conditions in the environment (such as traffic flows), where the information is associated with different types of data sources distributed in the environment, and the environment includes multiple intersections and roadways.

In some embodiments, the second information may include a location of the electronic device.

Note that the computer system may identify an event in at least a portion of the environment based at least in part on the information and/or the second information. Moreover, the computer system may perform a remedial action based at least in part on the identified event. For example, the remedial action may include: dynamically recomputing the route based at least in part on the identified event; or providing an alert about the event (e.g., to the user). In some embodiments, identifying the event may be based at least in part on historical traffic conditions in the environment.

Additionally, identifying the event may include predicting a change in a traffic condition in the environment in a subsequent time interval. Alternatively or additionally, identifying the event may include determining a change in the traffic conditions after the change has occurred. In some embodiments, identifying the event may include comparing the traffic conditions to predefined signatures of different types of events. Note that identifying the event may be based at least in part on a pretrained predictive model, such as a machine-learning model or a neural network.

The environment may include at least a portion of a city or a municipality.

Moreover, at least some of the information may include real-time information, such as information that is received as it is acquired by a given type of source.

Furthermore, receiving the information may include accessing the information in memory associated with the computer system and/or receiving the information from the different types of sources.

Additionally, the event may or may not be other than a traffic event and may impact the traffic conditions. For example, the event may include one or more of: a sporting event, an entertainment event, a weather condition, an accident, etc.

In some embodiments, the types of data sources may include data associated with one or more of: EMS (such as EMS vehicles), municipal or private vehicles (such as EMS vehicles, waste-removal vehicles, public-works vehicles, vehicles associated with another municipal agency, etc.), navigation software, mass transit systems (such as mass-transit vehicles, trains, buses, etc.), rideshare software or rideshare vehicles, calendar software (such as the planned or future schedules of one or more individuals or organizations), parking meters, parking lots, etc.

Note that the computed route may be based on transit times of multiple vehicles that are proximate to the vehicle in the environment. For example, the computed route may minimize transit times (or minimize idle times) of the vehicle and the vehicles to destinations. Alternatively or additionally, the computed route may minimize transit times of second vehicles having a higher priority than the vehicle in the environment (such as EMS vehicles, municipal vehicles, mass-transit vehicles, waste-removal vehicles, public-works vehicles, vehicles associated with another municipal agency, etc.). In some embodiments, the proximate vehicles may be located in a same region in the environment as the vehicle.

Another embodiment provides a computer-readable storage medium for use with the computer system. When executed by the computer system, this computer-readable storage medium causes the computer system to perform at least some of the aforementioned operations.

Another embodiment provides a method that may be performed by the computer system. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for performing a remedial action using a computer system of FIG. 1 in accordance with an embodiment of the present disclosure.

FIG. 3 is a drawing illustrating an example of communication among electronic devices in FIG. 1 in accordance with an embodiment of the present disclosure.

FIG. 4 is a flow diagram illustrating an example of a method for determining whether information is self-consistent using a computer system of FIG. 1 in accordance with an embodiment of the present disclosure.

FIG. 5 is a drawing illustrating an example of communication among electronic devices in FIG. 1 in accordance with an embodiment of the present disclosure.

FIG. 6 is a flow diagram illustrating an example of a method for dynamically aggregating vehicles into a group of vehicles using a computer system of FIG. 1 in accordance with an embodiment of the present disclosure.

FIG. 7 is a drawing illustrating an example of communication among electronic devices in FIG. 1 in accordance with an embodiment of the present disclosure.

FIG. 8 is a drawing illustrating an example of a group of vehicles in accordance with an embodiment of the present disclosure.

FIG. 9 is a flow diagram illustrating an example of a method for providing instructions using a computer system of FIG. 1 in accordance with an embodiment of the present disclosure.

FIG. 10 is a drawing illustrating an example of communication among electronic devices in FIG. 1 in accordance with an embodiment of the present disclosure.

FIG. 11 is a drawing illustrating an example of a route with an alert signifying an incident and the additional time added to the estimated time of arrival (ETA) at a destination in accordance with an embodiment of the present disclosure.

FIG. 12 is a drawing illustrating an example of a route in which the user uses as an alternate route in accordance with an embodiment of the present disclosure.

FIG. 13 is a block diagram illustrating an example of communication among electronic devices in accordance with an embodiment of the present disclosure.

FIG. 14 is a drawing illustrating an example of traffic-management techniques using a computer system of FIG. 1 in accordance with an embodiment of the present disclosure.

FIG. 15 is a drawing illustrating an example of traffic-management techniques using a computer system of FIG. 1 in accordance with an embodiment of the present disclosure.

FIG. 16 is a drawing illustrating an example of traffic-management techniques using a computer system of FIG. 1 in accordance with an embodiment of the present disclosure.

FIG. 17A is a drawing illustrating an example of unfiltered routes in accordance with an embodiment of the present disclosure.

FIG. 17B is a drawing illustrating an example of a filtered route in accordance with an embodiment of the present disclosure.

FIG. 18 is a drawing illustrating an example of a routing projection for a vehicle in accordance with an embodiment of the present disclosure.

FIG. 19 is a drawing illustrating examples of routing projections for a vehicle in accordance with an embodiment of the present disclosure.

FIG. 20 is a drawing illustrating an example of a routing projection for a vehicle in accordance with an embodiment of the present disclosure.

FIGS. 21-23 are drawings illustrating examples of routes for a vehicle in accordance with an embodiment of the present disclosure.

FIG. 24 is a drawing illustrating an example of traffic-management techniques using a computer system of FIG. 1 in accordance with an embodiment of the present disclosure.

FIG. 25 is a flow diagram illustrating an example of a method for providing instructions using a computer system of FIG. 1 in accordance with an embodiment of the present disclosure.

FIG. 26 is a drawing illustrating an example of communication among electronic devices in FIG. 1 in accordance with an embodiment of the present disclosure.

FIG. 27 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that manages traffic and traffic-light patterns is described. During operation, the computer system may receive information from a traffic-management system of an environment and second information from at least an instance of traffic-mapping software associated with an electronic device of a user, where the information specifies the traffic-light patterns in a time interval. Then, the computer system may compute a route, for at least a vehicle associated with the user from a current location associated with the electronic device to a destination based at least in part on the information and the second information. Next, the computer system may provide instructions addressed to the electronic device, where the one or more instructions specify the computed route.

By jointly including the information and the second information, the traffic-management techniques may allow an improved route and/or ETA to be determined. Notably, the traffic-management techniques may address the fragmented nature of existing traffic-management solutions. For example, the traffic-management techniques may allow routes to be determined for multiple vehicles, while including the impact of the determined routes on municipal vehicles (such as EMS vehicles and/or buses). Consequently, the traffic-management techniques may provide improved solutions that may reduce driver and municipality frustration with existing traffic-management solutions.

Moreover, by performing the remedial action, determining whether the information is self-consistent and/or dynamically aggregating the vehicles into the group of vehicles, these traffic-management techniques may reduce the cost, simplify and/or improve the performance of a traffic-management system. For example, by using different types of sources, the traffic-management techniques may avoid the siloed nature of many existing traffic-management systems. Moreover, the traffic-management techniques may provide a dynamic, real-time response to changing conditions in a coordinated or synchronized manner over a signification portion of the environment (as opposed to a local response at a particular intersection). Furthermore, the traffic-management techniques may provide these capabilities without requiring additional cameras or sensors to be installed in intersections or along roadways, or to be included in vehicles. Consequently, the traffic-management techniques may reduce the cost and complexity of a traffic-management system. Additionally, by leveraging the different types of sources, the traffic-management techniques may allow unreliable or suspect data to be eliminated or to bound or limit the impact of such data in a traffic-management system. Therefore, the traffic-management techniques may increase the reliability or trustworthiness of alerts, instructions and/or remedial actions provided by or performed by a traffic-management system. These capabilities of the traffic-management techniques may result in improved traffic conditions, increased commercial activity, and reduce pollution and carbon emissions, which are beneficial to drivers, businesses and municipalities.

Note at least a portion of the traffic-management techniques may be implemented in a distributed or decentralized manner. Alternatively, in some embodiments, at least a portion of the traffic-management techniques may be implemented in a centralized manner.

In the discussion that follows, electronic devices (such as vehicles and/or computers) may communicate packets or frames with wired and/or wireless networks (e.g., via access points, radio nodes and/or base stations) in accordance with a wired communication protocol (such as an Institute of Electrical and Electronics Engineers or IEEE 802.3 standard, which is sometimes referred to as ‘Ethernet’, or another type of wired interface) and/or a wireless communication protocol, such as: an IEEE 802.11 standard (which is sometimes referred to as ‘Wi-Fi,’ from the Wi-Fi Alliance of Austin, Texas), Bluetooth (from the Bluetooth Special Interest Group of Kirkland, Washington), a cellular-telephone communication protocol (such as 2G, 3G, 4G, 5G, Long Term Evolution or LTE, another cellular-telephone communication protocol, etc.) and/or another type of wireless interface. In the discussion that follows, Wi-Fi, a cellular-telephone communication protocol and Ethernet are used as an illustrative example. However, a wide variety of communication protocols may be used. Note that the wireless communication may occur in a variety of frequency bands, such as: a cellular-telephone communication band, a frequency band associated with a Citizens Band Radio Service, a Wi-Fi frequency band (such as a 2.4 GHz, a 5 GHz, a 6 GHz, a 7 GHz and/or a 60 GHz frequency band), etc.

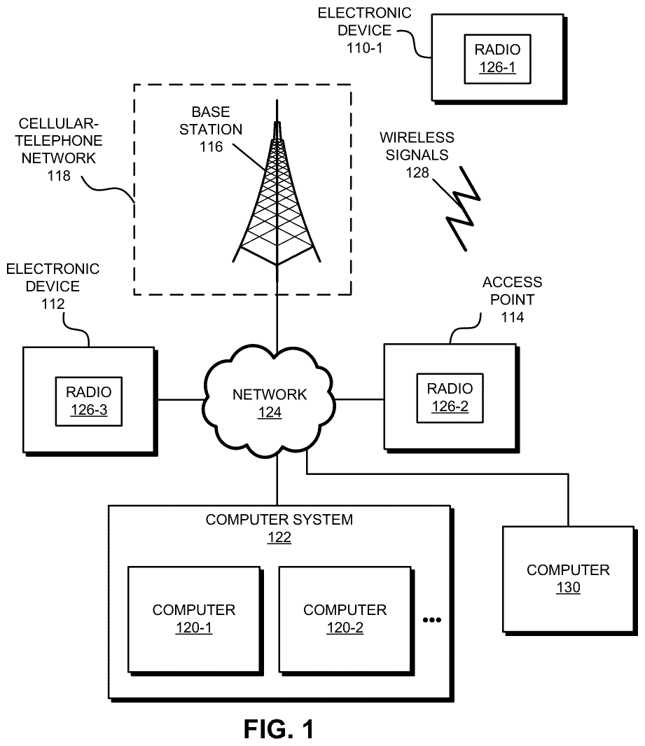

FIG. 1 presents a block diagram illustrating an example of communication among one or more of electronic devices 110-1 and 112 (such as a cellular telephone, a vehicle, a computer, etc., and which are sometimes referred to as ‘clients’), access point 114, base station 116 in cellular-telephone network 118, and one or more computers 120 in computer system 122 in accordance with some embodiments. For example, electronic devices 110-1 and 112 may be in an environment, such as a city, a town or a municipality. In general, the environment may include incorporated or unincorporated regions. Moreover, the environment may include multiple intersections and/or roadways. Consequently, as discussed further below, information about or corresponding to traffic conditions that us collected or aggregated in the environment may include distributed information over a wide region (as opposed to local information associated with a particular intersection or a particular portion of a roadway).

Access point 114 and base station 116 may communicate with computer system 122 via network 124 (such as the Internet) using wireless and/or wired communication (such as by using Ethernet or a communication protocol that is compatible with Ethernet), and may communicate with electronic device 110-1 using wireless communication (Wi-Fi and a cellular-telephone communication protocol, respectively). Note that access point 114 may include a physical access point and/or a virtual access point that is implemented in software in an environment of an electronic device or a computer. In addition, access point 114 and/or base station 116 may communicate with electronic device 110-1 using wireless communication, while electronic device 112 may communicate with computer system 122 via network 124.

While not shown in FIG. 1, the wired and/or wireless communication with electronic devices 110-1 and/or 112 may further occur via an intranet, a mesh network, point-to-point connections, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication in FIG. 1 also involves the use of dedicated connections, such as via a peer-to-peer (P2P) communication technique.

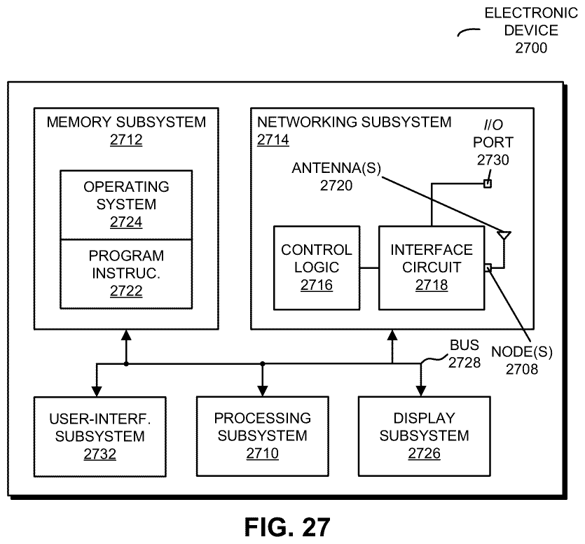

As described further below with reference to FIG. 27, electronic device 110-1, electronic device 112, access point 114, base station 116, and/or computers 120 may include subsystems, such as a networking subsystem, a memory subsystem and a processor subsystem. In addition, electronic device 110-1, access point 114 and base station 116 may include radios 126 in the networking subsystems. More generally, electronic device 110-1, electronic device 112 and access point 114 can include (or can be included within) any electronic devices with the networking subsystems that enable electronic device 110-1 and access point 114 to communicate with each other using wireless and/or wired communication. This wireless communication can comprise transmitting advertisements on wireless channels to enable access point 114 and/or electronic device 110-1 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic device 110-1 and access point 114, one or more of these instances may be different from the other instances of radios 126.

As can be seen in FIG. 1, wireless signals 128 (represented by a jagged line) are transmitted from radio 126-1 in electronic device 110-1. These wireless signals may be received by radio 126-2 in access point 114. Notably, electronic device 110-1 may transmit packets or frames. In turn, these packets or frames may be received by access point 114. Moreover, access point 114 may allow electronic device 110-1 to communicate with other electronic devices, computers and/or servers via network 124.

Note that the communication among components in FIG. 1 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic device 110-1 and/or access point 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

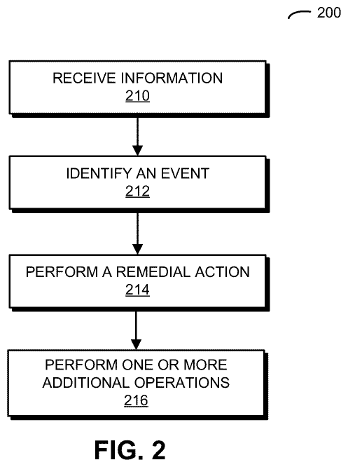

As described previously, existing traffic-management solutions are often inflexible, expensive and complicated. As described further below with reference to FIGS. 2-8, in order to address these problems, computer system 122 may implement the traffic-management techniques. Notably, the traffic-management techniques may leverage different types of sources distributed through an environment to facilitate reliable real-time or dynamic traffic management.

For example, in some embodiments, computer system 122 may receive information corresponding to traffic conditions in an environment (such as traffic flows), where the information is associated with different types of sources distributed in the environment, and the environment includes multiple intersections and roadways. For example, the information may be received from electronic devices 110-1 and/or 112 in an environment, such as a city or a municipality.

Then, computer system 122 may identify an event in at least a portion of the environment based at least in part on the information. For example, the event may be identified based at least in part on: historical traffic conditions in the environment; a detected previous or a predicted future change in a traffic condition in the environment (such as in the next 5, 10, 30 or 60 min.). In some embodiments, identifying the event may include comparing the traffic conditions to predefined signatures of different types of events. Note that identifying the event may be based at least in part on a pretrained predictive model, such as a machine-learning model or a neural network.

Next, computer system 122 may perform a remedial action based at least in part on the identified event. For example, computer system 122 may: provide an alert about the event (e.g., to pedestrians or drivers in at least the portion of the environment, such as a vehicle that includes electronic device 110-1); providing an instruction based at least in part on the event (e.g., to the drivers in at least the portion of the environment); and/or modifying traffic management (such as road signage, traffic signal timing, etc.) in at least the portion of the environment (e.g., by providing instructions to a computer 130 associated with a traffic-management system).

In some embodiments, computer system 122 may check the received information to ensure that it is self-consistent, e.g., with itself or with expected traffic conditions at a location and a given timestamp in the environment (such as based at least in part on historical traffic conditions and/or estimated traffic conditions based at least in part on an output of a pretrained predictive model). This capability may allow computer system 122 to identify unreliable, suspicious or repetitive data, and to remove or exclude such data from subsequent operations of computer system 122 (such as inclusion in a dataset that is used to dynamically retrain a pretrained predictive model or to determine a modification to traffic management). More generally, when information is not self-consistent, computer system 122 may selectively perform a remedial action.

Additionally, in some embodiments, computer system 122 may dynamically aggregates vehicles into a group of vehicles. For example, based at least in part on traffic conditions corresponding to the received information, as well as start locations and destination locations of the vehicles, computer system 122 may dynamically aggregate the vehicles into the group of vehicles. Then, computer system 122 may provide traffic-management instructions addressed to a traffic-management system (such as computer 130), where the traffic-management instructions allow the vehicles to navigate through the environment as the group of vehicles. For example, navigating through the environment as the group of vehicles may include maintaining spatial proximity of the vehicles with each other. Thus, the vehicles may collectively navigate through the environment as a common entity.

In these ways, the traffic-management techniques may leverage real-time communication with traffic signals to reduce congestion on roadways, provide coordinated right-of-way for emergency vehicles, and/or reduce accidents at intersections with traffic signals.

While the preceding embodiments illustrated the traffic-management techniques being implemented via a cloud-based computer system 122, in other embodiments at least some of the aforementioned operations may be performed locally on, e.g., electronic device 110-1 or 112. Thus, operations in the traffic-management techniques may be performed locally or remotely.

We now describe embodiments of a method. FIG. 2 presents a flow diagram illustrating an example of a method 200 for performing a remedial action using a computer system, such as one or more computers 120 in computer system 122 (FIG. 1). During operation, the computer system may receive information (operation 210) corresponding to traffic conditions in an environment, where the information is associated with different types of sources distributed in the environment, and the environment includes multiple intersections and roadways. In the present disclosure, a ‘traffic condition’ may include one or more of: a number or density of vehicles on a portion of a roadway or proximate to an intersection; types of vehicles (such as bicycles, scooters, motorcycles, cars, trucks, buses, delivery vehicles, garbage trucks, emergency vehicles, autonomous or autonomous-driving vehicles, etc.) on the portion of the roadway or proximate to the intersection; a number of pedestrians proximate to a roadway, an intersection or at a mass-transit location (such as walking on the sidewalk or waiting at a bus stop); a speed of traffic; acceleration or deceleration of traffic; the occurrence of or proximity to a phase transition in traffic flow (such as stop and go traffic); disruptions or changes to traffic flow (such as an accident, police, ambulance or fire department activity, etc.); deviations of a vehicle (such as a bus) from a schedule or when the vehicle is on time or following the schedule; when traffic has come to a stop, how long it has been stopped, how many vehicles are waiting, etc.; a number of people using mass transit; traffic signal states; traffic signal periods or patterns; or another factor that directly or indirectly impacts a traffic condition or reflects or indicates the traffic condition.

Note that the environment may include at least a portion of a city or a municipality. Moreover, at least some of the information may include real-time information, such as information that is received as it is acquired by a given type of source. As discussed further below, this may allow the computer system to dynamically and appropriately respond in a timely manner to changing traffic conditions in the environment.

Furthermore, receiving the information (operation 210) may include accessing the information in memory associated with the computer system and/or receiving the information from the different types of sources. In some embodiments, the types of data sources may include data associated with one or more of: emergency services calls, municipal or private vehicles (such as emergency-services vehicles, waste-removal vehicles, public-works vehicles, vehicles associated with another municipal agency, autonomous or autonomous-driving vehicles, etc.), navigation software, mass transit systems (such as mass-transit vehicles, trains, buses, etc.), rideshare software or rideshare vehicles, taxis, calendar software (such as the planned or future schedules of one or more individuals or organizations), parking meters, parking lots, airborne or terrestrial unmanned drones or robots, etc. Note that the use of or merging of disparate and/or geographically distributed types of sources may avoid the adverse effects of siloed information.

Then, the computer system may identify an event (operation 212) in at least a portion of the environment based at least in part on the information. Moreover, identifying the event may be based at least in part on historical traffic conditions in the environment. Furthermore, identifying the event may include predicting a change in a traffic condition in the environment in a subsequent time interval. Alternatively or additionally, determining identifying the event may include determining a change in the traffic conditions after the change has occurred. In some embodiments, identifying the event may include comparing the traffic conditions to predefined signatures of different types of events (such as traffic conditions associated with different types of events). Note that identifying the event may be based at least in part on a pretrained predictive model, such as a machine-learning model or a neural network.

In some embodiments, the event may or may not be other than a traffic event, but may impact the traffic conditions. For example, the event may include one or more of: a sporting event, an entertainment event (such as a concert or a theatrical performance), a weather condition, a political event, a conference, terrorism, etc. Alternatively, the event may include an accident.

Next, the computer system may perform a remedial action (operation 214) based at least in part on the identified event. For example, the remedial action may include: providing an alert about the event (e.g., to pedestrians, cyclists or drivers in at least the portion of the environment); providing an instruction based at least in part on the event (e.g., to the drivers in at least the portion of the environment); and/or modifying traffic management (such as road signage, traffic signal timing, etc.) in at least the portion of the environment. Notably, when the event includes an accident at a location in the environment, the modification to the traffic management (such as a traffic-signal period or warning signs) may dynamically reduce a probability of a future occurrence of an accident at the location. Alternatively or additionally, modifying the traffic management may include changing: a number of vehicles in a group of vehicles allowed through an intersection during a traffic-signal cycle and/or a spacing between vehicles in the group. In some embodiments, where the event includes an emergency services response to a 911 call), modifying the traffic management may include adjusting the timing of multiple traffic signals along a route to allow emergency vehicles to safely and efficiently reach a destination (such as a location of the 911 call or a potential emergency) with reduced or improved transit time and reduced acceleration and deceleration.

Moreover, the alert or the instruction may be provided to delivery vehicles, such as trucks, unmanned drones or robots. For example, the alert or instruction may provide a truck, a drone or a robot information that, directly or indirectly, indicates how to address the identified event (such as a preferred route to a destination, specific portions of the environment to avoid at certain timestamps, etc.).

In some embodiments, the alert or the instructions is based at least in part on a predicted impact of or corresponding to the event on a future traffic condition, e.g., because of a modification in traffic management associated with the event. Note that the alert or the instruction may be provided to users or drivers (or electronic devices of users or drivers) in a synchronized or coordinated manner. For example, the alert or the instruction may be provided in a staggered manner (such as with a determined delay or latency) to the users or drivers in different zones or regions in the environment based at least in part on the predicted impact on the traffic conditions of the responses of the users or drivers to the alert or the instruction.

In some embodiments, the computer system performs one or more optional additional operations (operation 216). For example, the remedial action may be based at least in part on: dividing the environment into multiple zones or regions; and dynamically controlling traffic flows between different regions based at least in part on predefined traffic parameters or constraints.

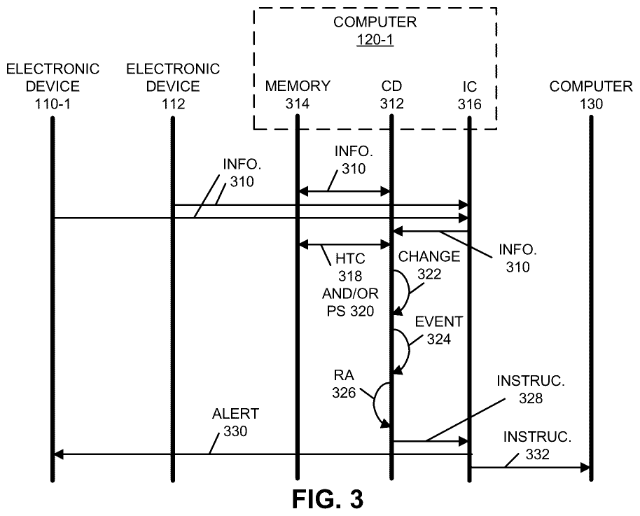

FIG. 3 presents a drawing illustrating an example of communication among electronic device 110-1, electronic device 112, computer 120-1 and computer 130. During the traffic-management techniques, computer 120-1 may receive information 310 corresponding to traffic conditions in an environment. For example, computational device (CD) 312 (such as a processor or a graphics processing unit) in computer 120-1 may access information 310 in memory 314 in computer 120-1. Alternatively or additionally, interface circuit 316 in computer 120-1 may receive information 310 from different types of sources (ToS) distributed in the environment, such as electronic device 110-1 and/or electronic device 112. For example, electronic device 110-1 may include a municipal vehicle and electronic device 112 may include a cellular telephone executing a rideshare application or a navigation (or mapping) software.

Then, computational device 312 may identify an event 324 in at least a portion of the environment based at least in part on information 310. The event 324 may be identified based at least in part on historical traffic conditions (HTC) 318 in the environment or predefined signatures (PS) 320 of different types of events, which are accessed in memory 314. Furthermore, identifying event 324 may include determining a change 322 that occurred or predicting a change 322 in a traffic condition in the environment in a subsequent time interval.

Next, computational device 312 may perform a remedial action (RA) 326 based at least in part on the identified event 318. For example, remedial action 326 may include: instructing 328 interface circuit 316 to provide an alert 330 to drivers (e.g., via their cellular telephones or navigation software or another application executing on their cellular telephones, such as electronic device 110-1) or an instruction 332 to a traffic-management system (such as computer 130).

In some embodiments, the types of sources include data from public transportation (such as buses) and/or any type of municipal vehicle. These information or data may indicate traffic conditions along the main routes or roadways in an environment, such as a city. Thus, the information may be received from a traffic participant and may (or may not) be associated with location-based cellular-telephone data. In some embodiments, the information may be independent of a Global Positioning System (GPS). For example, the information may include or may correspond to images acquired by external and/or internal cameras on a bus or another type of municipal vehicle. This information may allow the location to be determined based at least in part on street sign(s) or identifying information associated with a particular roadway.

Note that, for a given vehicle, the data or information may include or may indicate one or more of: whether the given vehicle (such as a bus) is on schedule (or whether there is a deviation from the schedule); a speed of the given vehicle; a number of people on the vehicle; human behavior associated with the given vehicle (such as opening and/or closing of doors); a number of people waiting to board the given vehicle; a density of vehicles and associated traffic flow or traffic conditions in front of and/or behind the given vehicle; etc.

In some embodiments, the computer system may acquire one or more images from one or more cameras in a vehicle, such as a mass-transit vehicle. At least some of the information used in the traffic-management techniques may be obtained by performing an image-processing or an image-analysis technique on the one or more images. This image-processing or image-analysis technique may include: an edge or a line-segment detector, a texture-based feature detector, a texture-less feature detector, a scale invariant feature transform (SIFT)-like object-detector, a speed-up robust-features (SURF) detector, a binary-descriptor (such as ORB) detector, a binary robust invariant scalable keypoints (BRISK) detector, a fast retinal keypoint (FREAK) detector, a binary robust independent elementary features (BRIEF) detector, a features from accelerated segment test (FAST) detector, and/or another image-processing or image-analysis technique. Alternatively or additionally, in some embodiments the image may be analyzed using a pre-trained predictive or machine-learning model. In the present discussion, note that a pre-trained predictive machine-learning model may have been trained using a machine-learning technique, such as a supervised-learning technique. The supervised-learning technique may include: a classification and regression tree, a support vector machine (SVM), linear regression, nonlinear regression, logistic regression, least absolute shrinkage and selection operator (LASSO), ridge regression, a random forest, and/or another type of supervised-learning technique. In some embodiments, the pre-trained predictive or machine-learning model may include a pre-trained neural network, such as a convolutional neural network or a recurrent neural network. Note that the received information may or may not be encrypted using an encryption key or a secure hash function that is shared by one or more electronic devices (such as computer system 122 and electronic devices 110-1 and/or 112).

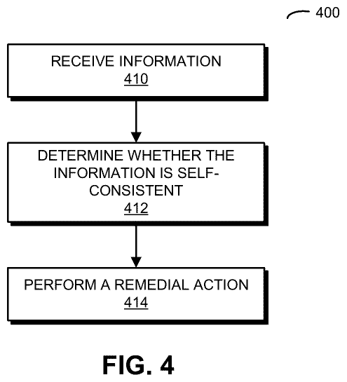

FIG. 4 presents a flow diagram illustrating an example of a method 400 for determined whether information is self-consistent using a computer system, such as one or more computers 120 in computer system 122 (FIG. 1). During operation, the computer system may receive information (operation 410) corresponding to traffic conditions in an environment, where the information is associated with different types of sources distributed in the environment, and the environment includes multiple intersections and roadways. Note that the environment may include at least a portion of a city or a municipality. In some embodiments, the types of data sources may include data associated with one or more of: emergency services calls (such as 911 calls), municipal or private vehicles (such as emergency-services vehicles, waste-removal vehicles, public-works vehicles, vehicles associated with another municipal agency, etc.), navigation software, mass transit systems (such as mass-transit vehicles, trains, buses, etc.), rideshare software or rideshare vehicles, calendar software (such as the planned or future schedules of one or more individuals or organizations), parking meters, parking lots, etc.

Then, the computer system may determine whether the information is self-consistent (operation 412). (More generally, the computer system may determine whether the information is correct or reliable.) Next, the computer system may selectively perform a remedial action (operation 414) when at least some of the information is not self-consistent.

Note that at least some of the information associated with the different types of sources may be redundant, overlapping or concerning the same thing. For example, at least some of the redundant information may be associated with a common traffic condition in the environment and/or a common intersection or roadway in the environment. Notably, there may be information from at least two different types of sources that is associated with a roadway, an intersection or a traffic condition on the roadway or in the intersection at a given timestamp. The self-consistency of this information may be determined by comparing the information from the different types of sources. When there is a difference, either or both of these types of sources may be deemed unreliable or lacking self-consistency in the information. Thus, when data from one type of source (such as a ridesharing application) indicates traffic is moving slowly (below the speed limit) at the current timestamp, while data from another type of source (such as a municipal vehicle, such as a bus) indicates that traffic is moving at the speed limit at the current timestamp, the ridesharing-application data may be deemed incorrect or unreliable because of this lack of self-consistency.

Alternatively, a particular type of source (such as data associated with municipal vehicles) may be deemed to be more reliable or the types of sources may have associated reliability values or metrics in a predefined reliability hierarchy, such as: data for municipal vehicles may be deemed inherently more reliable than data associated with an external source (outside of the municipality), such as data associated with a consumer application (e.g., navigation software, rideshare software, etc.). In some embodiments, agreement among a majority of the types of sources may be deemed reliable or self-consistent, and one or more types of sources that are outliers may be deemed unreliable or lacking self-consistence.

Furthermore, determining whether the information is self-consistent may be based at least in part on predefined rules associated with historical traffic conditions in the environment (e.g., at a given timestamp). For example, deviations or changes from a historical traffic pattern or flow (and, more generally, a traffic condition) at the given timestamp may be deemed suspicious (or lacking self-consistency) in the absence of an explanation (such as the identification of an event that can impact of the change the traffic condition. Alternatively, determining whether the information is self-consistent may be based at least in part on a comparison of the traffic conditions corresponding to the information and predicted traffic conditions (e.g., using a pretrained predictive model, such as a machine-learning model and/or a neural network) based at least in part on the information and/or historical traffic conditions in the environment (e.g., at a given timestamp).

When at least some of the information is not self-consistent or is deemed unreliable, the remedial action may include excluding this data in the information (such as conflicting data). Alternatively or additionally, redundant data in the information (such as duplicate or temporally repeating data) may be deemed as lacking self-consistency and may be removed or excluded by the computer system. Thus, repeated instances of the same or similar data may be ignored or removed from consideration is subsequent actions of the computer system (such as a modification to traffic management). This capability may allow the computer system to avoid a spoofing attack or a denial-of-service attack.

In some embodiments, the remedial action may include bounding or limiting a modification to traffic management (such as road signage, traffic signal timing, etc.) in at least a portion of the environment based at least in part on the information. This capability may prevent or limit an adverse impact of data that is suspect or incorrect. For example, the modification to the traffic management may be constrained by one or more historical traffic conditions at a given location in at least the portion of the environment. Consequently, the final or output modification to the traffic management may be determined based at least in part on low-pass filtering, systematic under relaxation (such as limiting a given modification to less than a 1-5% change from previous traffic-management parameters or settings, e.g., a traffic-signal timing or period) or averaging with the one or more historical traffic conditions and an estimated or predicted traffic condition associated with an initial modification to the traffic management. This may ensure that any changes or modifications are incremental and take place over a time interval (such as up to 1, 5, 10 or 30 min).

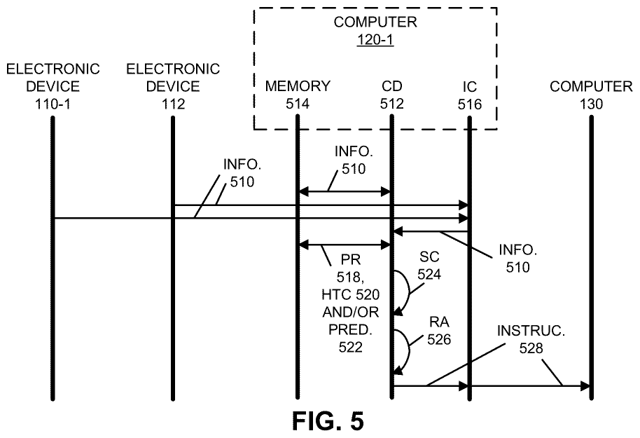

FIG. 5 presents a drawing illustrating an example of communication among electronic device 110-1, electronic device 112, computer 120-1 and computer 130. During the traffic-management techniques, computer 120-1 may receive information 510 corresponding to traffic conditions in an environment. For example, computational device (CD) 512 (such as a processor or a graphics processing unit) in computer 120-1 may access information 510 in memory 514 in computer 120-1. Alternatively or additionally, interface circuit 516 in computer 120-1 may receive information 510 from different types of sources (ToS) distributed in the environment, such as electronic device 110-1 and electronic device 112. For example, electronic device 110-1 may include a municipal vehicle and electronic device 112 may include a cellular telephone executing a rideshare application or a navigation (or mapping) software.

Then, computational device 512 may determine whether information 510 is self-consistent (SC) 524. For example, computational device 512 may compare information 510 to itself (such as overlapping or redundant information). These comparisons may involve different types of sources, and may confirm that at least a majority of the information is in agreement with each other. Outliers that differ from the majority may be deemed unreliable or lacking self-consistency. Note that in the comparisons, at least some of the information associated with one or more type of sources may be deemed more reliable that information associated with one or more other types of sources.

Moreover, the determining may be based at least in part on predefined rules (PR) 518 and/or a historical traffic conditions (HTC) 520, which are accessed in memory 514. Alternatively or additionally, the determining may be based at least in part one one or more predictions 522 e.g., such as one or more traffic conditions predicted using a pretrained predictive model.

Next, computational device 512 may selectively perform a remedial action (RA) 526 when at least some of information 510 is not self-consistent. For example, unreliable or information lacking self-consistency may be excluded or removed. Alternatively or additionally, redundant data in the information (such as duplicate or temporally repeating data) may be deemed as lacking self-consistency and may be removed or excluded by computational device 512. In some embodiments, remedial action 526 may include determining an instruction 528 that is provided by interface circuit 516 addressed to a traffic-management system (such as computer 130). Instruction 528 may modify road signage, traffic signal timing, etc. based at least in part on at least a portion of information 510 that is deemed reliable or self-consistent. Note that the modification provided to the traffic-management system (including a centralized traffic-management computer system and/or a distributed components in the traffic-management system) may be bounded or limited, e.g., so that suspect or incorrect data does not adversely impact the traffic-management system.

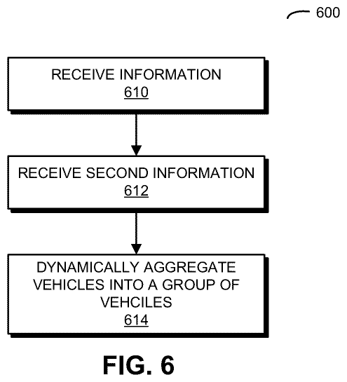

FIG. 6 presents a flow diagram illustrating an example of a method 600 for dynamically aggregates vehicles into a group of vehicles using a computer system, such as one or more computers 120 in computer system 122 (FIG. 1). During operation, the computer system may receive information (operation 610) corresponding to traffic conditions in an environment, where the information is associated with different types of sources distributed in the environment, and the environment includes multiple intersections and roadways. Note that the environment may include at least a portion of a city or a municipality. Then, the computer system may receive second information (operation 612) corresponding to start locations in the environment of the vehicles and destination locations in the environment of the vehicles.

Moreover, the computer system may dynamically aggregate the vehicles into the group of vehicles (operation 614) based at least in part on the traffic conditions, the start locations and the destination locations. For example, the computer system may calculate that the vehicles will have a reduced transit time from their start locations to their destination locations when they transit or navigate through the environment in the group of vehicles. In some embodiments, the calculation may use or may leverage a scheduling or network-queue-management technique for improving or optimizing packet transport in a router or a switch in a network, as well as physics-based constraints (such as constraints on a spacing between vehicles, acceleration and deceleration rates of a given vehicle, etc.). Note that depending on the time of day, day of the week, time of year, and/or the traffic conditions, the computer system may include fewer or more vehicles in the group of vehicles. Notably, the number of vehicles in the group of vehicles may be based at least in part on estimated transmit times of the vehicles in the group of vehicles (such as estimated transmit times that are computed using a pretrained predictive model, e.g., a machine-learning model and/or a neural network). In general, the group of vehicles may include two or more vehicles that share at least a portion of their routes from their start locations to their destination locations, and for which the estimated transit times of each of the two or more vehicles is reduced when included in the group of vehicles (when compared to the estimated transit times when not included in the group of vehicles). However, when it is not advantageous (e.g., when the transmit times of each of the vehicles is reduced), the computer system may not aggregate the group of vehicles, e.g., each car may independently navigate through the environment.

Next, the computer system may provide traffic-management instructions (operation 616) addressed to a traffic-management system, where the traffic-management instructions allow the vehicles to navigate through the environment as the group of vehicles. For example, the instructions may be provided to a centralized portion of the traffic-management system or to individual traffic signals or lights (along a route of the group of vehicles) in a distributed portion of the traffic-management system. Note that navigating through the environment as the group of vehicles may include maintaining spatial proximity of the vehicles with each other. Thus, the vehicles may collectively navigate through the environment as a common entity.

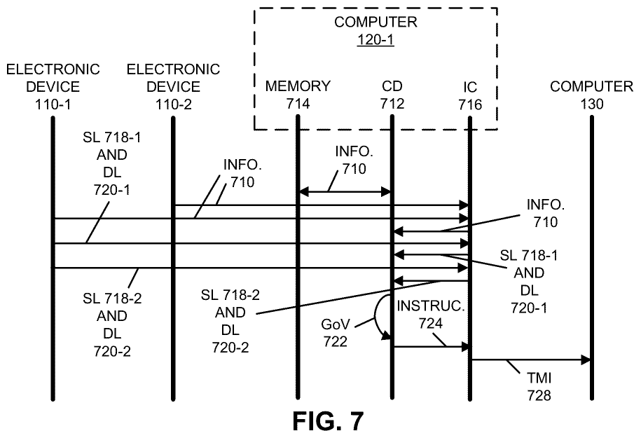

FIG. 7 presents a drawing illustrating an example of communication among electronic device 110-1, electronic device 110-2, computer 120-1 and computer 130. Note that electronic device 110-1 may be included in a first vehicle and electronic device 110-2 may be included in a second vehicle. During the traffic-management techniques, computer 120-1 may receive information 710 corresponding to traffic conditions in an environment. For example, computational device (CD) 712 (such as a processor or a graphics processing unit) in computer 120-1 may access information 710 in memory 714 in computer 120-1. Alternatively or additionally, interface circuit 716 in computer 120-1 may receive information 710 from different types of sources distributed in the environment, such as electronic devices 110-1 and/or 110-2.

Then, electronic device 110-1 may provide start location (SL) 718-1 and a destination location (DL) 720-1 to computer 120-1. Moreover, electronic device 110-2 may provide start location 718-2 and a destination location 720-2 to computer 120-1.

After receiving start locations 718 and destination locations 720, interface circuit 716 may provide start locations 718 and destination locations 720 to computational device 712. Moreover, computational device 712 dynamically aggregate or group the first vehicle and the second vehicle into a group of vehicles (GoV) 722 based at least in part on the traffic conditions corresponding to information 710, start locations 718 and destination locations 720.

Next, computational device 712 may instruct 724 interface circuit 716 to provide traffic-management instructions (TMI) 726 addressed to a traffic-management system (such as computer 130), where the traffic-management instructions 726 allow the first vehicle and the second vehicle to navigate through the environment as the group of vehicles 722. Note that navigating through the environment as the group of vehicles 722 may include maintaining spatial proximity of the first vehicle and the second vehicle with each other, such as maintaining a spacing between the first vehicle and the second vehicle that is less than a predefined value (e.g., 1-5 car lengths or 15-100 ft). For example, the traffic-management instructions 726 may ensure that the first vehicle and the second vehicle pass through intersections together and/or that the first vehicle and the second vehicle drive sequentially without any intervening vehicles between them. Moreover, the traffic-management instructions 726 may optionally be dynamically provided to the first vehicle and the second vehicle, so that the first vehicle and the second vehicle accelerate or decelerate at the same time (e.g., without delay or lag) and with the same or a common magnitude.

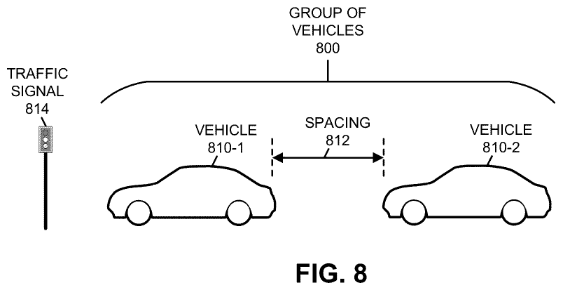

The navigating through the environment as the group of vehicles is shown in FIG. 8 presents a drawing illustrating an example of a group of vehicles 800. Notably, the traffic-management instructions may ensure that vehicles 810 in the group of vehicles 800 may maintain spatial proximity, such as a spacing 812 that is less than a predefined value. In some embodiments, spacing 812 may be dynamically adjusted based at least in part on a speed of the group of vehicles 800, such as one car length (e.g., 15-20 ft.) per 10 mph or speed. However, in other embodiments, while spacing 812 may be dynamically adjusted based at least in part on a speed of the group of vehicles 800, spacing 812 may be less than one car length (e.g., 15-20 ft.) per 10 mph of speed. Alternatively in some embodiments, spacing 812 may be fixed, such as one car length (e.g., 15-20 ft.).

Note that the computer system may facilitate the operation of the group of vehicles 800 and the navigation of the group of vehicles 800 in the environment. For example, the traffic-management instructions may ensure each of vehicles 810 operations as a common entity, such as by jointly accelerating and decelerating at the same time (e.g., without lag or delay) or with a predefined staggered lag or delay (e.g., less than 1 s) along a sequence of vehicles in group of vehicles 800 that is less than a human lag or delay. Moreover, the group of vehicles 800 may accelerate or decelerate using a common magnitude.

Furthermore, the traffic-management instructions may ensure that that traffic signals (such as traffic signal 814) allows vehicles 810 in the group of vehicles 800 to all passthrough intersections together. For example, the group of vehicles 810 may be given priority in an intersection, such as by controlling traffic signal 814. Note that when a given vehicle (such as vehicle 810-1) reaches its destination location or a turnoff from a common route of the group of vehicles 800 for its destination location, the traffic-management instructions may remove vehicle 810-1 from the group of vehicles 800. More generally, during the navigation through the environments, one or more vehicles may be added to or removed from the group of vehicles 800.

In these ways, the dynamically aggregated group of vehicles 800 may allow vehicles 810 to navigate through the environment more efficiently than, e.g., vehicles that are not included in the group of vehicles 800. Thus, the dynamic aggregation may reduce travel times, fuel consumption and pollution associated with the group of vehicles 800.

We now further describe the traffic-management techniques. Congestion in many countries is at a point where building new roads will not improve traffic (at best, there may be a short-term improvement before stalemate occurs again). Moreover, traffic lights or signals typically indiscriminately affect all road users by physically controlling the intersection right-of-way.

The disclosed traffic-management techniques may provide improved performance, e.g., in the form of coordinated signal timing and authorized right-of-way, without the need for total system upgrades. Notably, coordinating traffic lights for the reduction of congestion may provide a major benefit to the entire economy. Moreover, reducing idle time and the continual loop of acceleration/deceleration to each light can reduce emissions, save fuel and improve safety. Furthermore, with traffic signal information, first-responder or emergency vehicles and mass-transit vehicles (such as buses) can be given advanced notice of right-of-way traffic conditions along their route.

Additionally, the traffic-management techniques may address traffic-industry pain points, such as: traffic control is typically a hardware-based industry (such as traffic signals at intersections, which are usually only adapted by at most semi-annual traffic studies by third-party consultants) and is cost-intensive; public transportation usually pays for installation, maintenance, timing studies, and cost of priority solutions, and the high cost of competing hardware solutions often means that transit agencies only have enough money for a specific section of roadway or a high-priority bus service; and emergency responders (such as fire, police and ambulance) typically use a hardware-based, line-of-sight solution, which may increase equipment maintenance problems. Note that traffic-signal maintenance and operation is usually less than 10% of a city traffic engineers responsibility. Moreover, traffic-signal timing can directly affect community well-being and the cost of doing business (such as shipping costs). Consequently, many cities and municipalities are looking for new ways of handling traffic and performing traffic control in their communities. In addition, many cities and municipalities are looking to reduce the need for specialized or proprietary hardware in traffic cabinets and on signal mast arms, which adds additional complexity and maintenance costs.

In some embodiments, the traffic-management techniques may be used in a variety of use cases, including: transit signal priority (TSP), emergency vehicle preemption (EVP), and/or signal performance metrics (SPM). Notably, in TSP, machine learning (such as one or more pretrained predictive models) may be used to dynamically adjust time-traffic signal controllers to provide well-timed priority green lights to mass-transit vehicles serving their routes with minimal disruption to cross traffic. Moreover, in EVP, one or more emergency vehicles (such as police, fire trucks and ambulances) may be tracked in in real-time and traffic-signal controllers may be instructed to provide green lights while the one or more emergency vehicles travel to reach their destination. Furthermore, in SPM, valuable, down-to-the-second insights of individual intersection activity and/or traffic-signal controller configuration and performance may be determined and/or provided.

These capabilities (which be implemented in a local and/or a cloud-based solution) may allow machine learning to be used to analyze multiple live or real-time data feeds and to prioritize the flow of vehicles by controlling traffic signals in real-time across and between entire city regions, zones or grids. Consequently, the traffic-management techniques may allow big data to be applied to traffic flow.

Moreover, the traffic-management techniques may provide: prescriptive traffic-signal timing from vehicle-arrival predictions (and, more generally, predicted traffic conditions); vehicle-arrival predictions (and, more generally, predicted traffic conditions) based at least in part on machine learning; real-time vehicle data processing and decision making; and/or standardized/simplified connection handling between different vehicle data stores.

Furthermore, the traffic-management techniques may offer: reduced cost relative to hardware-based solutions (e.g., because of the reduction or elimination of equipment at intersections); improved flexibility (such as the ability to update pretrained predictive models to address transmit route changes); and/or a less complicated implementation (e.g., communication between the computer system and a traffic-management system may occur via one electronic device that is installed at a traffic-management center in a given city or municipality, and different services, such as TSP, EVP, etc. can be added without any additional equipment).

Based at least in part on the traffic-management techniques, traffic lights in communities may rarely be manually configured by traffic engineers. Instead, the computer system may know the configuration of traffic lights based at least in part on the integrated traffic platform that uses multiple different types of sources (such as different vehicle and signal data sources) to dynamically configure traffic light. In some embodiments, the traffic-management techniques may reduce traffic in a given community by at least 30%.

Moreover, the traffic-management techniques may provide TSP and EVP in multiple communities, and may be easily deployed in a new community. Furthermore, mass-transit agencies may have increased ridership, lower fuel consumption, lower labor costs, and/or expanded service. Additionally, emergency-vehicle response times may be significantly reduced, thereby saving lives and protecting communities.

Thus, the traffic-management techniques may manage the information exchange between vehicles and roadways to control traffic signals and/or traffic signage to reduce congestion, increase safety, and/or save time. These capabilities may allow the way vehicles choose their routes around cities to be managed. Moreover, as autonomous or autonomous-driving vehicles advance into markets, the traffic-management techniques may be expanded to assist the autonomous or autonomous-driving vehicles with navigation and route planning.

Note that the traffic-management techniques may be used by a wide variety of types of customers, including: local, state and/or federal government agencies, state and local transportation departments, mass-transit agencies, police departments, fire departments, private ambulance services, traffic engineers, transit and urban planners, and/or first responders (such as an operations team).

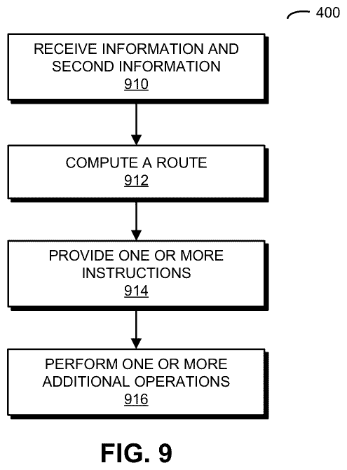

We now describe additional embodiments of the traffic-management techniques. These embodiments may leverage or share one or more features with another embodiment in the present disclosure. FIG. 9 presents a flow diagram illustrating an example of a method 900 for providing instructions using a computer system, such as computer system 122 (FIG. 1). During operation, the computer system may receive information (operation 910) from a traffic-management system of an environment and second information (operation 910) from at least an instance of traffic-mapping software associated with an electronic device of a user. Then, the computer system may compute a route (operation 912), for at least a vehicle associated with the user from a current location associated with the electronic device to a destination based at least in part on the information and the second information. Next, the computer system may provide one or more instructions (operation 914) addressed to the electronic device, where the one or more instructions specify or indicate the computed route.

Note that the information may include traffic conditions in the environment (such as traffic flows), where the information is associated with different types of data sources distributed in the environment, and the environment includes multiple intersections and roadways.

In some embodiments, the types of data sources may include data associated with one or more of: EMS (such as EMS vehicles), municipal or private vehicles (such as EMS vehicles, waste-removal vehicles, public-works vehicles, vehicles associated with another municipal agency, etc.), navigation software, mass transit systems (such as mass-transit vehicles, trains, buses, etc.), rideshare software or rideshare vehicles, calendar software (such as the planned or future schedules of one or more individuals or organizations), parking meters, parking lots, etc.

Moreover, the second information may include a location of the electronic device.

Note that the environment may include at least a portion of a city or a municipality.

Furthermore, at least some of the information may include real-time information, such as information that is received as it is acquired by a given type of source.

Additionally, receiving (operation 910) the information may include accessing the information in memory associated with the computer system and/or receiving the information from the different types of sources.

Note that the computed route may be based on transit times of multiple vehicles that are proximate to the vehicle in the environment. For example, the computed route may minimize transit times of the vehicle and the vehicles to destinations. Alternatively or additionally, the computed route may minimize transit times of second vehicles having a higher priority than the vehicle in the environment (such as EMS vehicles, municipal vehicles, mass-transit vehicles, waste-removal vehicles, public-works vehicles, vehicles associated with another municipal agency, etc.). In some embodiments, the proximate vehicles may be located in a same region in the environment as the vehicle.

In some embodiments, the computer system performs one or more optional additional operations (operation 916). For example, the computer system may identify an event in at least a portion of the environment based at least in part on the information and/or the second information. Furthermore, the computer system may perform a remedial action based at least in part on the identified event. For example, the remedial action may include: dynamically recomputing the route based at least in part on the identified event; or providing an alert about the event (e.g., to the user). In some embodiments, identifying the event may be based at least in part on historical traffic conditions in the environment.

Additionally, identifying the event may include predicting a change in a traffic condition in the environment in a subsequent time interval. Alternatively or additionally, identifying the event may include determining a change in the traffic conditions after the change has occurred. In some embodiments, identifying the event may include comparing the traffic conditions to predefined signatures of different types of events. Note that identifying the event may be based at least in part on a pretrained predictive model, such as a machine-learning model or a neural network.

Additionally, the event may or may not be other than a traffic event and may impact the traffic conditions. For example, the event may include one or more of: a sporting event, an entertainment event, a weather condition, an accident, etc.

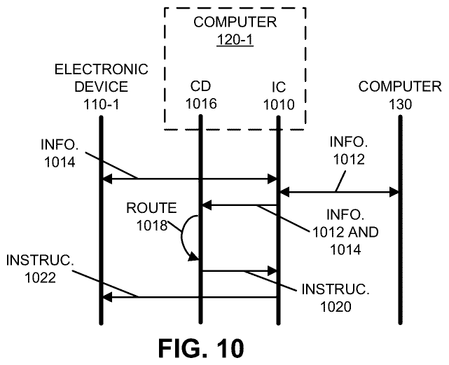

FIG. 10 presents a drawing illustrating an example of communication among electronic device 110-1, computer 120-1 and computer 130. During the traffic-management techniques, an interface circuit (IC) 1010 in computer 120-1 may receive information 1012 from a traffic-management system of an environment and second information 1014 from at least an instance of traffic-mapping software associated with electronic device 110-1 of a user. For example, traffic-management system may be executed by computer 130, and information 1012 may be accessed in memory (such as memory associated with computer 130).

Then, interface circuit 1010 may provide information 1012 and 1014 to computational device (CD) 1016 (such as a processor or a graphics processing unit) in computer 120-1. Using information 1012 and 1014, computational device 1016 may compute a route 1018, for at least a vehicle associated with the user, from a current location associated with electronic device 110-1 to a destination.

Next, computational device 1016 may instruct 1020 interface circuit 1010 to provide one or more instructions 1022 addressed to electronic device 110-1, where the one or more instructions 1022 specify or indicate the computed route 1018.

After receiving the one or more instructions 1022, instance of traffic-mapping software executing on electronic device 110-1 may display the computed route 1018, e.g., using an interactive map on a display in electronic device 110-1.

In some embodiments, information 1012 may include data from the types of sources, e.g., data from public transportation (such as buses) and/or any type of municipal vehicle. This information 1012 or data may indicate traffic conditions along the main routes or roadways in an environment, such as a city. Thus, information 1012 may be received from a traffic participant and may (or may not) be associated with location-based cellular-telephone data. In some embodiments, information 1012 may be independent of a Global Positioning System (GPS). For example, information 1012 may include or may correspond to images acquired by external and/or internal cameras on a bus or another type of municipal vehicle. This information may allow the location to be determined based at least in part on street sign(s) or identifying information associated with a particular roadway.

Note that, for a given vehicle, the data or information 1012 may include or may indicate one or more of: whether the given vehicle (such as a bus) is on schedule (or whether there is a deviation from the schedule); a speed of the given vehicle; a number of people on the vehicle; human behavior associated with the given vehicle (such as opening and/or closing of doors); a number of people waiting to board the given vehicle; a density of vehicles and associated traffic flow or traffic conditions in front of and/or behind the given vehicle; etc.

We now further describe the traffic-management techniques. These traffic-management techniques may provide clear, real-time and dynamic coordination between traffic-mapping software (or applications) and traffic-management systems. This coordination may facilitate planning and control in environments, such as a city, a municipality and, more generally, urban areas.

Referring back to FIG. 1, electronic devices (such as electronic device 110-1, e.g., a cellular telephone, a portable electronic device, or another electronic device, etc.) in an environment may communicate using wireless communication with a cellular-telephone network 118 (which may include a base station 116 or a radio node. For example, the communication may use LTE or a cellular-telephone data communication protocol. In some embodiments, the radio node may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In some embodiments, the wireless communication may be with access point 114 in a WLAN and may be compatible with an IEEE 802.11 communication protocol. Note that access point 114 may include a physical access point and/or a virtual access point that is implemented in software in an environment of an electronic device or a computer.

Furthermore, electronic devices 110-1 may optionally communicate with computer system 122, computer system 130 (which may include one or more computers or servers and which may be implemented locally or remotely to provide storage and/or analysis services) and/or electronic device 112 using a wired communication protocol (such as Ethernet) via network 124. For example, network 124 may be a LAN, an intranet, or the Internet. In some embodiments, the wired communication protocol may include a secured connection over transmission control protocol/Internet protocol (TCP/IP) using hypertext transfer protocol secure (HTTPS). Additionally, in some embodiments, network 124 may include one or more routers and/or switches.

Note that electronic device 110-1, computer system 122 and/or computer system 130 may implement at least some of the operations in the traffic-management techniques.

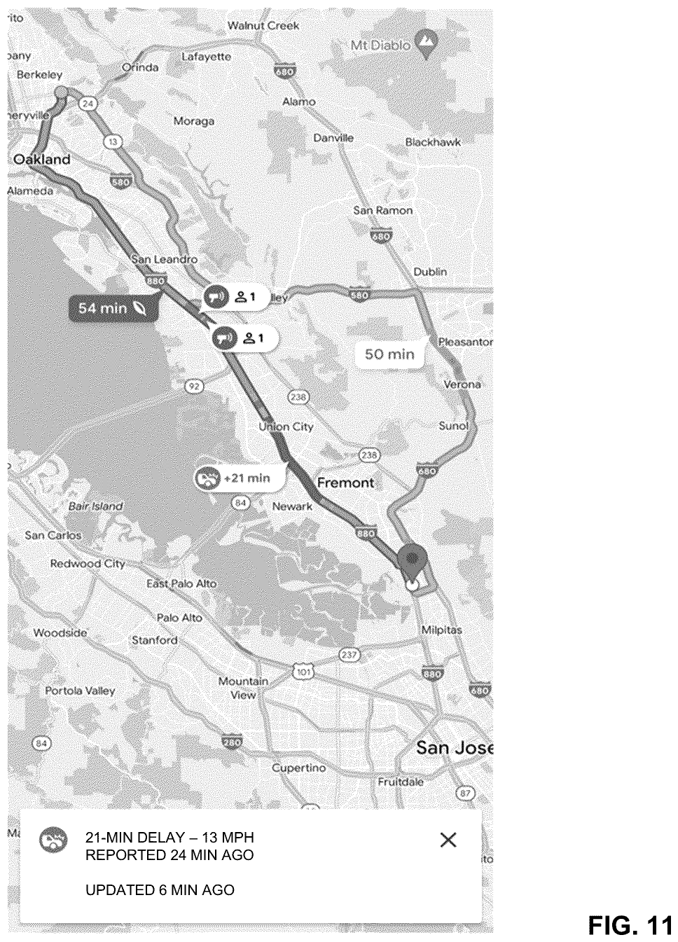

FIG. 11 presents a drawing illustrating an example of a route with an alert signifying an incident and the additional time added to the ETA at a destination. Notably, FIG. 11 illustrates the impact of the incident on the route without rerouting and its impact on EMS and traffic. The EMS traffic directed to the scene may be delayed or blocked on the route.

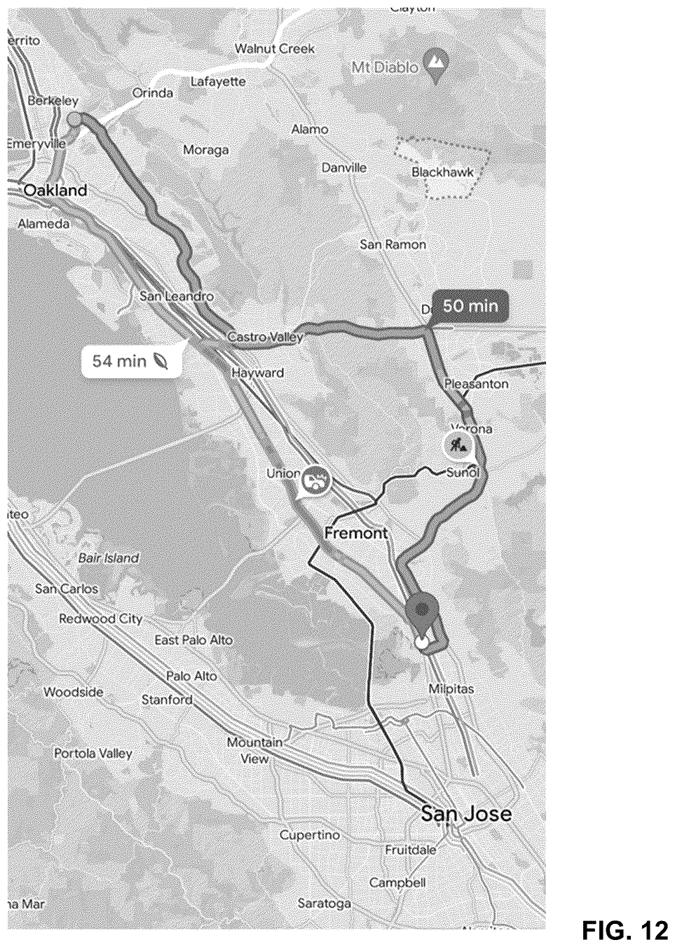

FIG. 12 presents a drawing illustrating an example of a route in which the user uses an alternate route. This alternate route may be the user's choice, but therefore may result in a random and uncontrolled load re-distribution on specific routes. These redistributions may not favor normal traffic patterns and may, directly and indirectly, cause increased traffic loads. Furthermore, there may not be any information in a cloud-based system (such as computer system 130) to guide decisions regarding the route(s) of EMS traffic and/or freeing up routes for EMS traffic.

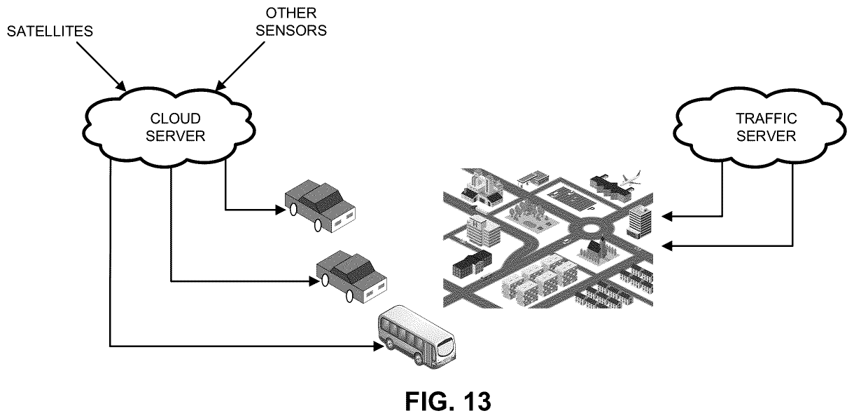

FIG. 13 presents a block diagram illustrating an example of communication among electronic devices. Notably, there may be two types of computer systems that control the system in FIG. 13. A cloud-based computer system may manage and interact with vehicles via, e.g., instances of traffic-mapping software. Moreover, a traffic server may manage traffic lights and may make traffic in a city flow as easy as possible to all participants based at least in part on local priorities, such as EMS should get higher priority that mass transit (such as buses), etc.

In general, traffic in this system may be affected by: the traffic control server and a map (or traffic-mapping) application control server. The traffic control server may send signals to the traffic control throughout the city and may have input from sensor devices throughout the city (which may provide traffic-load information). The traffic control server may also have access to historical information about traffic load and patterns. Note that the map application server may be responsible for handling routing decisions based at least in part on its sensor inputs, traffic incidents and real-time patterns. However, the map application server may not be aware of local traffic, such as EMS real-time events and traffic management, or the management of bus routes and status, and/or other city-base traffic.

In order to address this problem, the disclosed traffic-management techniques may provide an interface between the traffic control system and the cloud-based map application server, and may provide additional inputs and choices to drivers. For example, the map application server interactively may know some or all of the vehicle's destinations and current locations. When a vehicle changes its route, the cloud-based server may know about this, because it may provide a visual indication on a mobile electronic device via an interactive map. In order to provide an efficient traffic-management system, the local system may be aware, at least in part, of this information. The local traffic management system may receive this information from multiple map application servers and may consolidate this information and plan traffic accordingly. The local traffic management system may inform the cloud-based server of preferred routes and may manage the traffic load in each route as a change to the original plan because of traffic issues on the original main route. Note that the local traffic control system may handle these traffic changes automatically, e.g., using a machine-learning model to optimize results.

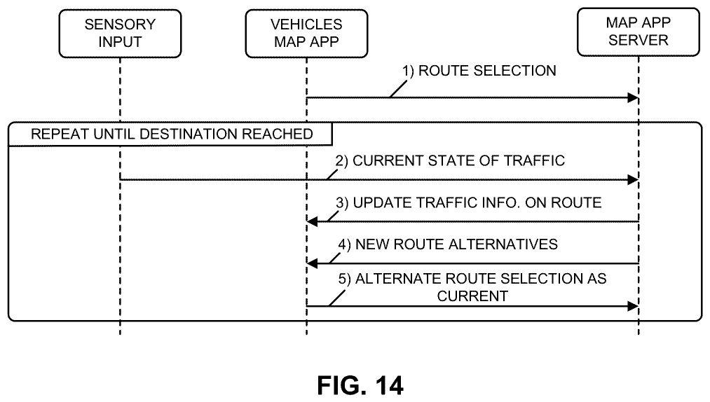

The traffic-management techniques are further illustrated in FIGS. 14-16. FIG. 14 presents a drawing illustrating an example of traffic-management techniques using computer system 122 (FIG. 1). Notably, FIG. 14 depicts the call flow between the cloud map application server and the vehicles. Initially, in operation 1, a user in a vehicle may use a map application to choose a route offered by the map application server to a specific destination. In operation 2, there may be sensory inputs, including satellite, local road assistant imaging and/or other sensor information, that provides input data to the map application server in the cloud. The map application server may (e.g., continuously) update the map application with traffic information and may propose alternatives that improve the time to the destination, which was selected in operation 1. Note that the alternative route may be selected by the map application (e.g., user selected), and the map application may notify the map application server of the new route selection. In some embodiments, the user may choose to change routes without notifying the server directly. The map application may send GPS coordinate information to the map application server, which may use this information to assume a new updated route and to provide new alternatives.

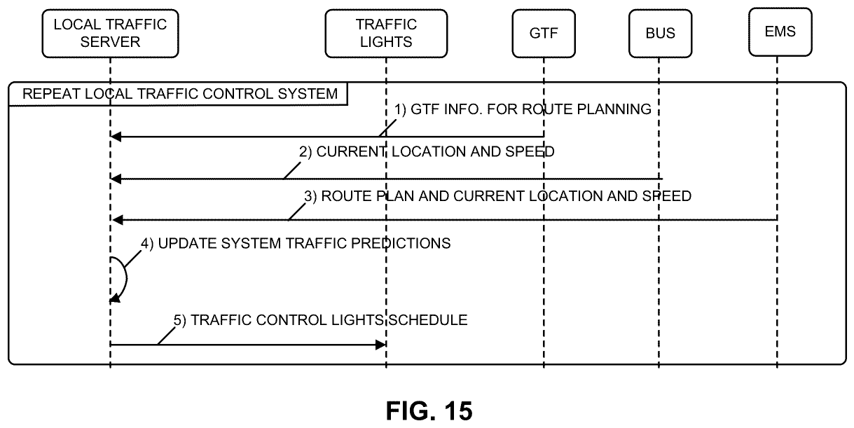

FIG. 15 presents a drawing illustrating an example of traffic-management techniques using computer system 122 (FIG. 1). Notably, FIG. 15 depicts the call flow between the traffic control system, EMS, buses, and traffic lights throughout a city (or a controlled area). In this call flow example, a General Transit Feed (GTF) is used. For example, in operation 1, the GTF may send transit bus route information to the local traffic control. In addition, continuous updates may be received from buses and EMS regarding route planning, physical location via GPS and other sensors like video. In operation 4, the local traffic server may update its traffic prediction. Notably, the local traffic server may use a traffic signal control systems to manage traffic light signal on/off durations along multiple routes in order to optimize traffic according to its priorities.

Note that the present disclosure presents two approaches or systems: a cloud-based map application server, and the local traffic management system. These two systems may benefit significantly from information sharing between them in real-time in order to optimize global map traffic based at least in part on both global and local traffic needs.

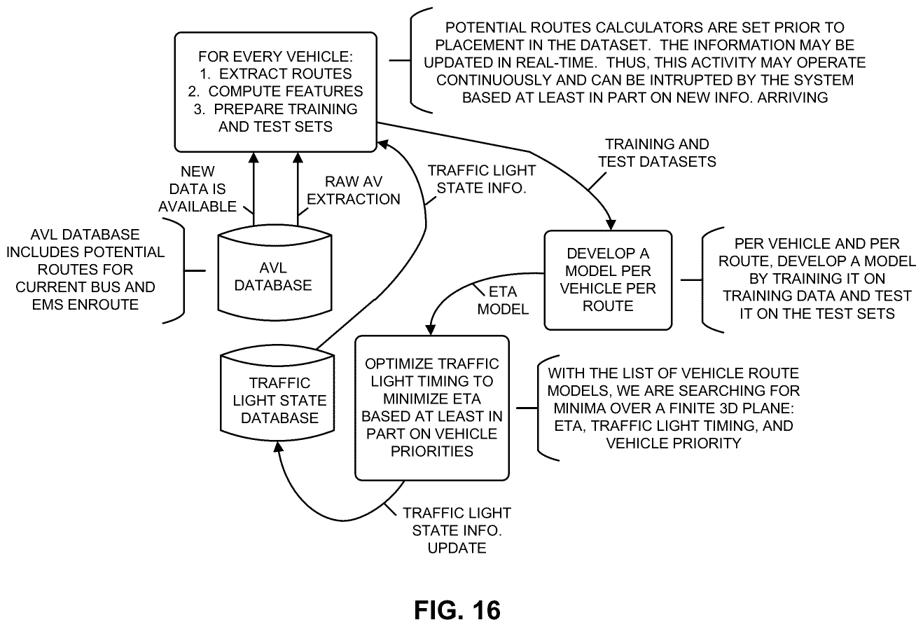

FIG. 16 presents a drawing illustrating an example of traffic-management techniques using computer system 122 (FIG. 1). Notably, FIG. 16 illustrates a model that depicts the local traffic management system based at least in part on optimizing the ETA.

In this model, there may be two data structures (e.g., databases). The first database may be an AVL database that includes past planned routes for known vehicles (such as buses) and potential routes, as well as new potential routes planned in real-time for EMS vehicles that must reach specific destinations based at least in part on incidents. The AVL database may include audio, video and/or other sensor-based information acquired in real-time by EMS, buses, public-works vehicles, infrastructure static sensors, and incident events reported on trusted public media. The system may generate its trusted feed based at least in part on a pretrained neural network (such as a large language model or LLM) scanning live media and public reporting events.

The second database may include the current state of traffic lights throughout the coverage area or environment. This database may include the current real-time known state (reported by the traffic light system) and a recommendation for the new or the next state to which the traffic light system should move with timing information. The local traffic management system may provide the future state of the traffic lighting. When a recommended new state or timing is accepted and deployed, the second database will reflect it as actual or the current state.

In FIG. 16, potential routes may be extracted, features may be computed, and training and test data may be prepared. The inputs may include the multiple potential routes per vehicle, vehicle priority, light frequency and state per light on every path, historical data regarding stops, time in stop relative to vehicle occupancy, the overall state of the path (including incidents reported), and/or impact probability and severity. These inputs may be calculated for every vehicle to train and test the a pretrained neural network model (such as a deep learning model).

Then, a predictive model may be trained per vehicle, which may help determine and idealize the ETA without handling the inter-vehicle and inter-path influence of the overall model. This may result in an ideal timing and ETZ model per vehicle that may work in most cases with high probability but does not consider the entire view.

Moreover, a neural network (such as a deep learning model) may be trained that includes all the current vehicles managed in the system and the optimal recommended path for buses, but also the top-3 routes for the EMS vehicles. EMS vehicles may be the high-priority vehicles in the system and, among themselves, may have priority as well. In this neural network model, priority may also be an input. In some embodiments, the best minimum that can be found in an N dimensions model (where N is a non-zero integer and there may be one minimum per EMS vehicle) to minimize the prioritized ETA or time in traffic for the vehicles in the system. Once a solution is obtained, it may be provided to the EMS vehicles with alternate route(s) as well as suggestion timing for the traffic lights to enable these routes.

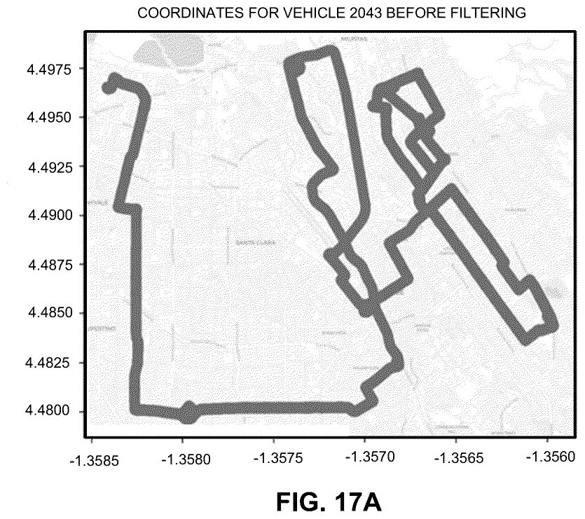

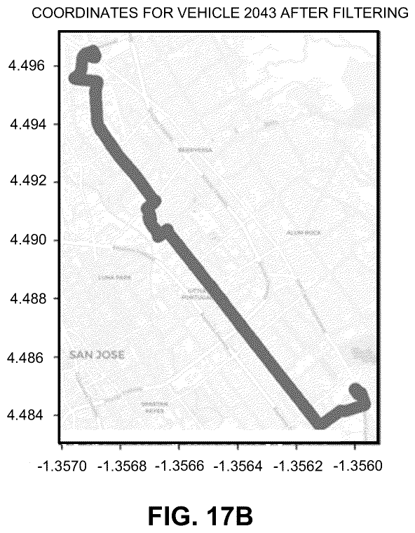

FIG. 17A presents a drawing illustrating an example of unfiltered routes and potential points for a route before filtering. Moreover, FIG. 17B presents a drawing illustrating an example of a filtered route. Note that the filtered route may include points that optimize the ETA. In the process of determining the filtered route points outside a route polygon may be discarded. In the case of buses, this process may result in a single route, while for other vehicles we may need to consider multiple optional routes between the current location and the destination. Note that the filtered route may provide a direction and timing on the route for the vehicle per extracted point.

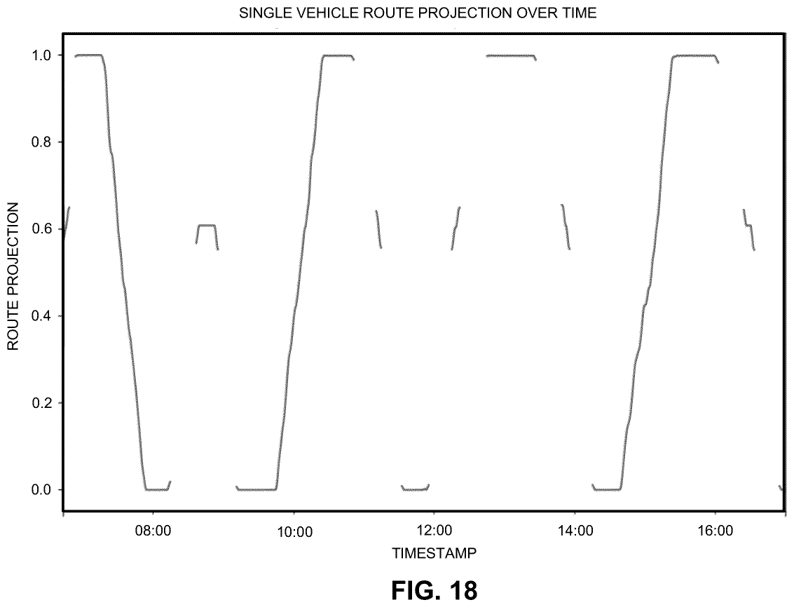

FIG. 18 presents a drawing illustrating an example of a routing projection for a vehicle. In FIG. 18, we see a depiction of a run as it is defined as a continuous span, where the bus is heading in a single direction. The run may be over when a bus changes direction, or there is a gap without data. Note that interpolation may make it look like there is a third potential route between 12:00 and 14:00 in this graph, but it may be filtered out because it contains large gaps. In order to detect direction changes, the signal may be shifted 5 minutes forward and 5 minutes backward to consider the difference. The large time interval used in these temporal shifts may allow for some noise in the signal, without splitting the run.

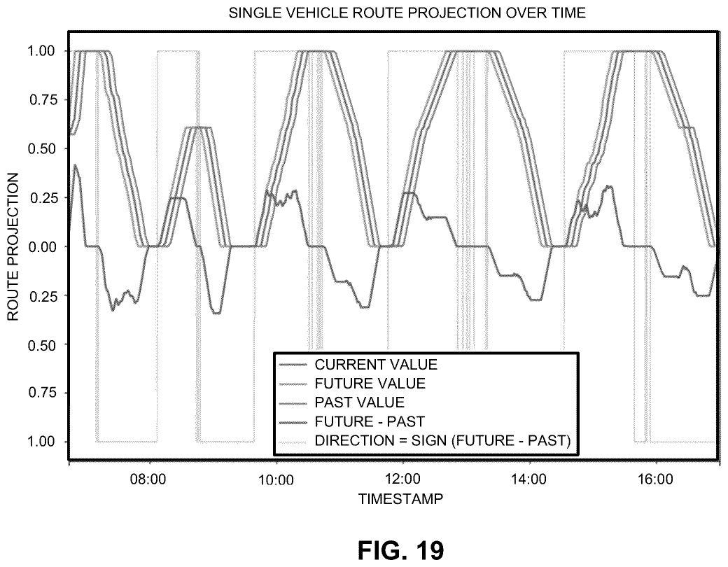

FIG. 19 presents a drawing illustrating examples of routing projections for a vehicle. In FIG. 19, we may make sure that there are no large gaps in the run itself and, thus, we may end up generating the ideal route. Then, we may progress to the next (and final) operation of route extraction.

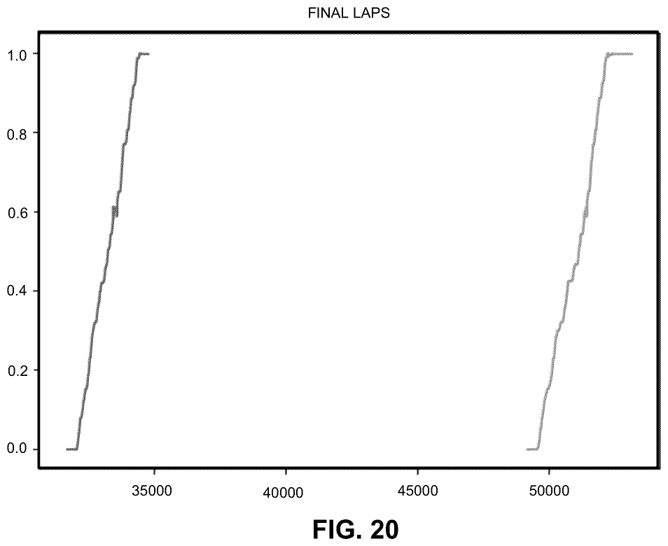

Notably, as shown in FIG. 20, which presents a drawing illustrating an example of a routing projection for a vehicle, a route may be clearly visible on a 2D map, including a predicted timing at each step along the path. However, this information may not be sufficient. Instead, we may need to extract a route relative to multiple route options.

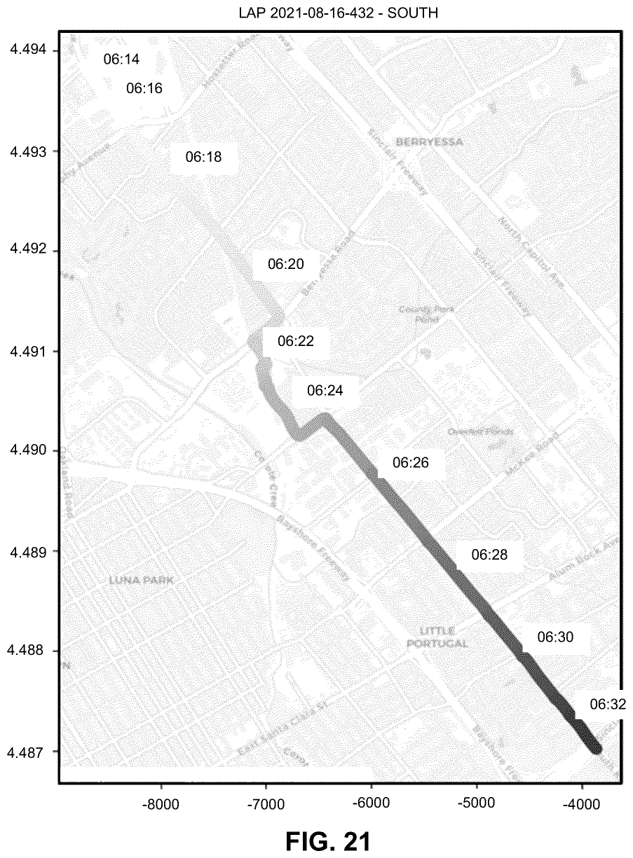

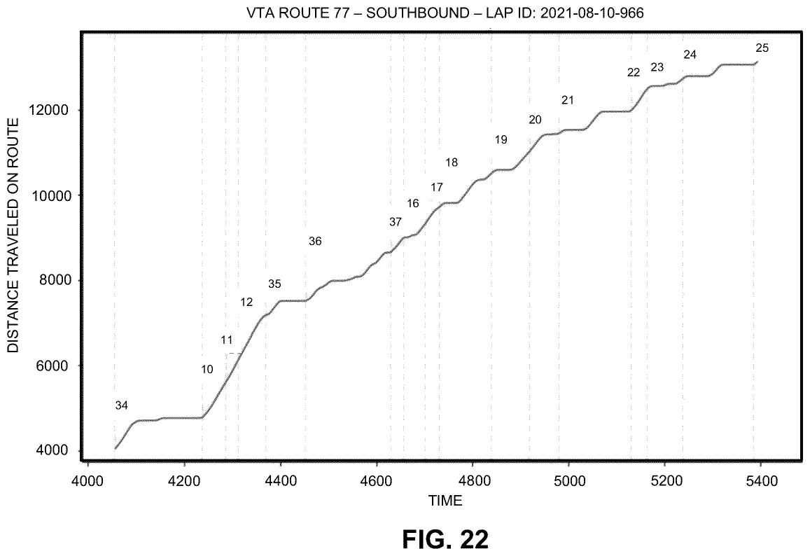

FIGS. 21-23 presents drawings illustrating examples of routes for a vehicle. In FIG. 21, the path extraction technique may compare multiple potential routes trying to optimize the ETA for the best ETA. However, as described in FIG. 16. there may be inner dependencies between routes, and choosing a route for one vehicle may impact the route(s) for another vehicle. Consequently in the traffic-management techniques, we may want to provide a global optimization. Thus, as we choose a route, we may go back and reexamine all other routes and align the optimized solutions accordingly. Choosing a route may only be a guess, because the dynamic traffic situation may change and that may influence routes. At every round of the analysis, we may provide the best solution predicted based at least in part on the current information.

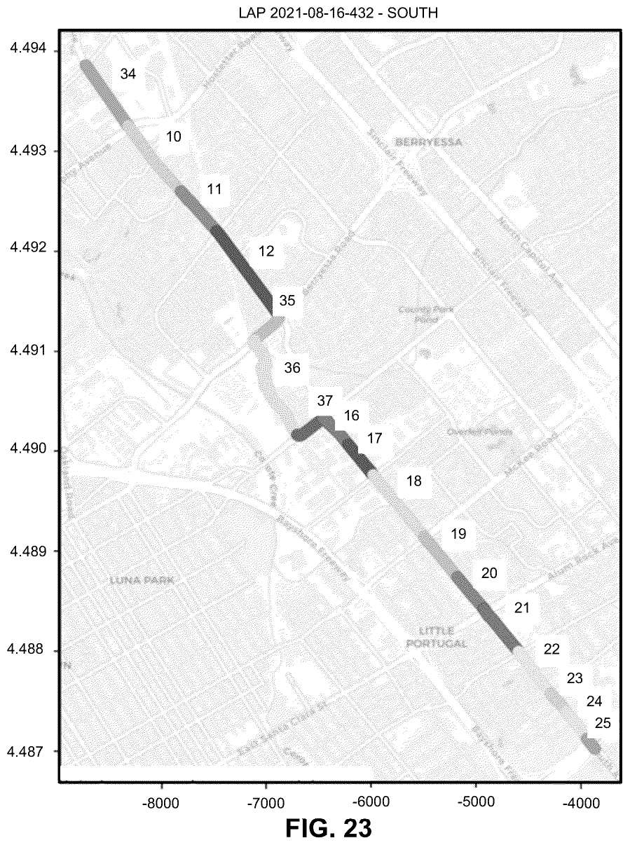

FIG. 23 presents a drawing illustrating an example of a route selected for a vehicle, including potential stops and traffic lights along the route. This solution may provide us with a good timing estimation assuming the traffic does not change appreciably while on route.

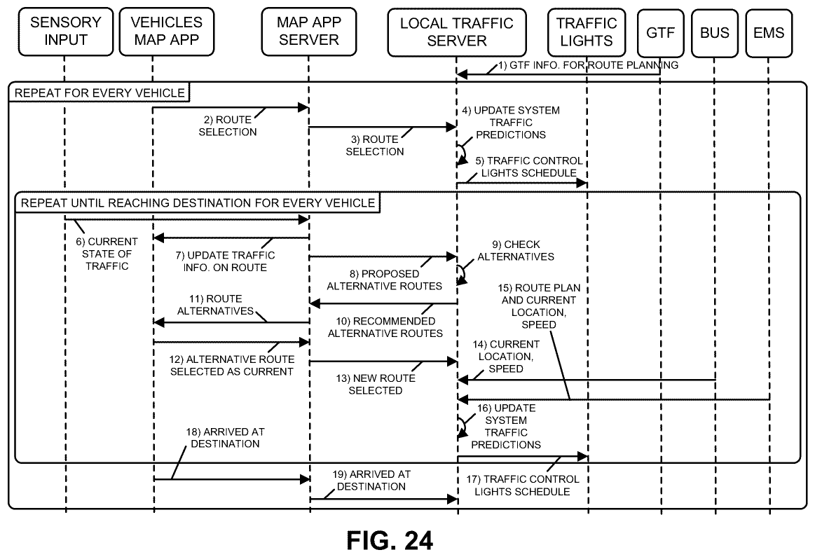

FIG. 24 presents a drawing illustrating an example of traffic-management techniques using computer system 122 (FIG. 1). Notably, FIG. 24 depicts a call flow for the integrated system of a map application server (for traffic-mapping software) and a traffic management or control system. In a first operation, a local traffic server may receive routes (including stop information) of buses and other public vehicles. Operation 1 may be performed for each change in planned routes or timing that may occur throughout the day.

In operation 2, the local traffic server, and the map application server, may receive route selection for every vehicle. The local traffic server may obtain information for EMS and other dynamic information that is not included in operation one and may being generated by those vehicles on an as-needed basis.

Moreover, in operation 3, the map application server may provide the dynamic selection of a route for every vehicle. This may provide the local server with enough information (operations 4 and 5) to optimize the traffic system to the best-planned timing when taking into consideration the entire traffic route selections.

In operations 6, 7 and 8, the map application server may generate revised proposed routes because of changes in the traffic environment and outlook. These optional routes may not be communicated to the drivers of these vehicles, e.g. these are preselects by the local vehicle.

Furthermore, in operations 9 and 10, the local traffic server may check alternate routes and may provide new recommendations to the map application server. The new recommendations may have a minimal impact on public traffic, while supporting rerouting of the mapped application-controlled vehicles.

Additionally, in operations 11, 12 and 13, the vehicles may be controlled (e.g., may receive instructions) by the map server selecting the routes and this information may be communicated as selected routes.

Note that in operations 14 and 15, the local controlled traffic (which may include EMS, buses, and other public vehicles) may send real-time information to the local traffic server, which in turn may take all traffic into consideration in operation 16 to generate the traffic light patterns in order to optimize arrival times based at least in part on the priority of the vehicles. In general, arrival at a destination may also be marked to remove this vehicle from the system. In some embodiments, the system may automatically remove vehicles based at least in part on predicted arrival times regardless of receiving this information. Note that this information may be used for training of one or more machine-learning models or predictive models.

Existing traffic-management techniques allow management of maps about satellite and sensor inputs. However, these approaches are reactionary. Typically, there is not any future planning based on plans (e.g., in what the traffic-management systems have planned) and what is currently occurring. Consequently, the result is usually not well optimized. For example, there may be interference with existing traffic flows traffic-management systems.

The disclosed traffic-management techniques may provide situational awareness, e.g., allowing a traffic-management system to integrate information from traffic-mapping software to respond to an event, such as an incident that changes traffic routing. However, the disclosed traffic-management techniques are not limited. Instead, they may allow or provide a continuous interface between traffic-mapping systems and a local traffic-management system, such that forward and real-time traffic control planning impacts the mapping suggestions and allows the user to receive a true view of current traffic conditions (as opposed to reactionary information). This capability may reduce delays in traffic flow(s).

Note that disclosed traffic-management techniques may allow, e.g., via a traffic-mapping system, one or more vehicles to provide information to the traffic-management system. For example, the traffic-management system may perform ground-traffic planning to group two or more vehicles into small groups that may facilitate more efficient management of one or more routes. The minimal group size may be a single vehicle. Grouping may be performed based at least in part on the destination, as opposed to the current location. When the destination is within predefined change or delta in distance or blocks (such as between 1-5 miles), the grouping may help provide cohesive routing of traffic. Note that the least efficient route management may be one vehicle at a time. However, sometimes this may be used in the traffic-management techniques in order to optimize traffic flow along specific traffic corridors or routes.

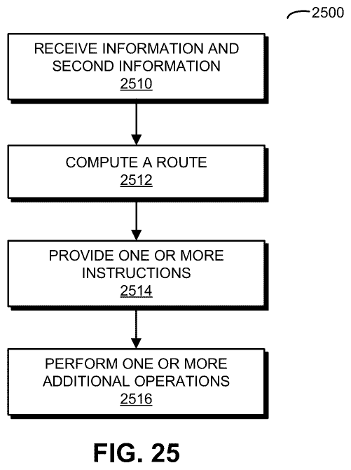

FIG. 25 presents a flow diagram illustrating an example of a method 2500 for providing instructions using a computer system, such as computer system 122 (FIG. 1). During operation, the computer system may receive information (operation 2510) from a traffic-management system of an environment and second information (operation 2510) from at least an instance of traffic-mapping software associated with an electronic device of a user, where the information specifies the traffic-light patterns in a time interval. Then, the computer system may compute a route (operation 2512), for at least a vehicle associated with the user from a current location associated with the electronic device to a destination based at least in part on the information and the second information. Next, the computer system may provide one or more instructions (operation 2514) addressed to the electronic device, where the one or more instructions specify or indicate the computed route.

Note that the route may be based at least in part on a predefined transportation goal. For example, the predefined transportation goal may include: pollution associated with the vehicle when navigating the route, energy consumption associated with the vehicle when navigating the route, travel time of the vehicle when navigating the route, battery life of a battery in the vehicle, and/or an idle time of the vehicle when navigating the route.

Moreover, a given traffic-light pattern in the traffic-light patterns may include states of the given traffic light and associated time durations, such as a duration of a green light, a duration of a yellow light, and a duration of a red light. Therefore, the given traffic-light pattern may specify when traffic is allowed to flow on particular roads in the environment.

Note that the information may include traffic conditions in the environment (such as traffic flows), where the information is associated with different types of data sources distributed in the environment, and the environment includes multiple intersections and roadways.

In some embodiments, the types of data sources may include data associated with one or more of: EMS (such as EMS vehicles), municipal or private vehicles (such as EMS vehicles, waste-removal vehicles, public-works vehicles, vehicles associated with another municipal agency, etc.), navigation software, mass transit systems (such as mass-transit vehicles, trains, buses, etc.), rideshare software or rideshare vehicles, calendar software (such as the planned or future schedules of one or more individuals or organizations), parking meters, parking lots, etc.

Moreover, the second information may include a location of the electronic device.

Note that the environment may include at least a portion of a city or a municipality.

Furthermore, at least some of the information may include real-time information, such as information that is received as it is acquired by a given type of source.

Additionally, receiving (operation 2510) the information may include accessing the information in memory associated with the computer system and/or receiving the information from the different types of sources.

Note that the computed route may be based on transit times of multiple vehicles that are proximate to the vehicle in the environment. For example, the computed route may minimize transit times of the vehicle and the vehicles to destinations. Alternatively or additionally, the computed route may minimize transit times of second vehicles having a higher priority than the vehicle in the environment (such as EMS vehicles, municipal vehicles, mass-transit vehicles, waste-removal vehicles, public-works vehicles, vehicles associated with another municipal agency, etc.). In some embodiments, the proximate vehicles may be located in a same region in the environment as the vehicle.

In some embodiments, the computer system performs one or more optional additional operations (operation 2516). For example, the computer system may provide, addressed to the traffic-management system, second instructions based at least in part on the route, where the second instructions include a change to at least one of the traffic-light patterns in a second time interval, and the second time interval is subsequent to the time interval.

Moreover, the computer system may identify an event in at least a portion of the environment based at least in part on the information and/or the second information. Furthermore, the computer system may perform a remedial action based at least in part on the identified event. For example, the remedial action may include: dynamically recomputing the route based at least in part on the identified event; or providing an alert about the event (e.g., to the user). In some embodiments, identifying the event may be based at least in part on historical traffic conditions in the environment.

Additionally, identifying the event may include predicting a change in a traffic condition in the environment in a subsequent time interval. Alternatively or additionally, identifying the event may include determining a change in the traffic conditions after the change has occurred. In some embodiments, identifying the event may include comparing the traffic conditions to predefined signatures of different types of events. Note that identifying the event may be based at least in part on a pretrained predictive model, such as a machine-learning model or a neural network.

The event may or may not be other than a traffic event and may impact the traffic conditions. For example, the event may include one or more of: a sporting event, an entertainment event, a weather condition, an accident, etc.

Note that in some embodiments of method 200 (FIG. 2), 400 (FIG. 4), 600 (FIG. 6), 900 (FIG. 9) and/or 2500, there may be additional or fewer operations. Furthermore, the order of the operations may be changed, there may be different operations and/or two or more operations may be combined into a single operation.

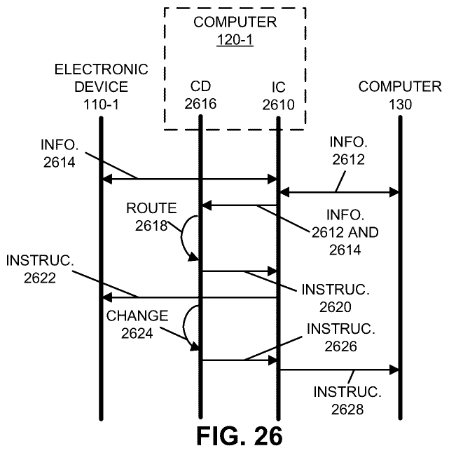

FIG. 26 presents a drawing illustrating an example of communication among electronic device 110-1, computer 120-1 and computer 130. During the traffic-management techniques, an interface circuit (IC) 2610 in computer 120-1 may receive information 2612 from a traffic-management system of an environment and second information 2614 from at least an instance of traffic-mapping software associated with electronic device 110-1 of a user. For example, traffic-management system may be executed by computer 130, and information 2612 may be accessed in memory (such as memory associated with computer 130). Note that the information may specify traffic-light patterns in a time interval, such as 1, 5, 10 or 30 minutes.

Then, interface circuit 2610 may provide information 2612 and 2614 to computational device (CD) 2616 (such as a processor or a graphics processing unit) in computer 120-1. Using information 2612 and 2614, computational device 2616 may compute a route 2618, for at least a vehicle associated with the user, from a current location associated with electronic device 110-1 to a destination.

Note that the route may be based at least in part on a predefined transportation goal. For example, the predefined transportation goal may include: pollution associated with the vehicle when navigating the route, energy consumption associated with the vehicle when navigating the route, travel time of the vehicle when navigating the route, battery life of a battery in the vehicle, and/or an idle time of the vehicle when navigating the route.

Next, computational device 2616 may instruct 2620 interface circuit 2610 to provide one or more instructions 2622 addressed to electronic device 110-1, where the one or more instructions 2622 specify or indicate the computed route 2618.

After receiving the one or more instructions 2622, instance of traffic-mapping software executing on electronic device 110-1 may display the computed route 2618, e.g., using an interactive map on a display in electronic device 110-1.

In some embodiments, computational device 2616 may compute a change 2624 to at least one of the traffic-light patterns in a second time interval based at least in part on route 2618, where the second time interval is concurrent or subsequent to the time interval. For example, the second time interval may include 1, 5, 10 or 30 minutes. Thus, computer 120-1 may dynamically manage route 2618 and/or at least one of the traffic-light patterns. This dynamic management may be interactive, so that a change to route 2618 may impact at least one of the traffic-light patterns and/or vice versa. Moreover, computational device 2616 may instruct 2626 interface circuit 2610 to provide one or more instructions 2628 addressed to the traffic-management system (e.g., which may be implemented, at least in part, using computer 130) of the environment, where the one or more instructions 2628 may indicate or specify change 2624.

Because changes to the traffic-light pattern (and, more generally, the traffic flows in the traffic management system) may impact the routes determined by the traffic-mapping software (and vice versa), the adaptations in the traffic-management techniques may be bidirectional. In order to ensure stability (e.g., of the traffic-management system), in some embodiments the traffic-light pattern is adjusted in a non-zero, discrete time interval following the determination of one or more routes using the traffic-mapping software. Stated differently, the non-zero second time interval may occur subsequent to the time interval. However, in other embodiments, the traffic-light pattern is adjusted concurrently with the routes determined by the traffic-mapping software. Stated differently, the time interval and the second time interval may overlap and, in some embodiments, may each by zero (i.e., the adaptations in the traffic-management techniques may occur dynamically and in real-time).

Moreover, in some embodiments, information 2612 may include data from the types of sources, e.g., data from public transportation (such as buses) and/or any type of municipal vehicle. This information 2612 or data may indicate traffic conditions along the main routes or roadways in an environment, such as a city. Thus, information 2612 may be received from a traffic participant and may (or may not) be associated with location-based cellular-telephone data. In some embodiments, information 2612 may be independent of a Global Positioning System (GPS). For example, information 2612 may include or may correspond to images acquired by external and/or internal cameras on a bus or another type of municipal vehicle. This information may allow the location to be determined based at least in part on street sign(s) or identifying information associated with a particular roadway.

Note that, for a given vehicle, the data or information 2612 may include or may indicate one or more of: whether the given vehicle (such as a bus) is on schedule (or whether there is a deviation from the schedule); a speed of the given vehicle; a number of people on the vehicle; human behavior associated with the given vehicle (such as opening and/or closing of doors); a number of people waiting to board the given vehicle; a density of vehicles and associated traffic flow or traffic conditions in front of and/or behind the given vehicle; etc.

While FIGS. 3, 5, 7, 10 and 26 illustrate communication between components using unidirectional or bidirectional communication with lines having single arrows or double arrows, in general the communication in a given operation in these figures may involve unidirectional or bidirectional communication. Moreover, while operations are illustrated in these figures sequentially, in some embodiments at least some of the operations may be performed in parallel.

In some embodiments, a driver of a vehicle may use an instance of traffic-mapping software on their cellular telephone (such as electronic device 110-1) to determine a route from a starting location (such as a current location of the vehicle) to a destination. The user may have previously selected or specified one or more transportation goals (which are sometimes referred to as one or more ‘predefined transportation goals’) to use when determining the optimal current route from the starting location to the destination. For example, the one or more predefined transportation goals may include: pollution associated with the vehicle when navigating the route (such as ‘green’ operation to reduce or minimize the pollution), energy consumption associated with the vehicle when navigating the route (such as determining the route to reduce or minimize the energy consumption, e.g., the amount of energy consumed from a battery), travel time of the vehicle when navigating the route (such as determining the route to reduce or minimize the travel time), battery life of a battery in the vehicle (such as determining the route to increase or maximize the battery life, e.g., during a current charge of the battery or the overall life of the battery), and/or an idle time of the vehicle when navigating the route (such as determining the route to reduce or minimize the idle time, e.g., at red traffic lights or in traffic). More generally, the one or more predefined transportation goals may define or specify the driver's or a user's aspirations for ‘travel efficiency’ when navigating the route from the start location to the destination.

The instance of the traffic-mapping software may (e.g., via a cloud-based server associated with the traffic-mapping software) provide, to computer 120-1, information specifying the start location, the destination, a current speed or a current velocity of the vehicle, and/or the one or more predefined transportation goals. Moreover, a traffic-management system (e.g., associated with computer 130) for an environment (such as a municipality or city) may provide, to computer 130-1, second information specify traffic conditions (such as vehicle flux, vehicle speed, estimated transit times associated with different potential routes, traffic events or disruptions, etc.). For example, the second information may include data from the types of sources, e.g., data from public transportation (such as buses) and/or any type of municipal vehicle. This second information may indicate traffic conditions along the main routes or roadways in the environment, such as a city. Note that the second information may include or may specify traffic-light patterns in the environment in a current time interval, such as 1, 5, 10 or 30 minutes.

Then, computer 120-1 may compute a route for the vehicle from the start location to the destination based at least in part on the information, the second information and the one or more transportation goals. For example, computer 120-1 may use the information and the second information as inputs to an optimization technique, the route may be an output of the optimization technique, and the one or more transportation goals may be used as constraints in the optimization technique. In some embodiments, the optimization technique may be based at least in part on these inputs and/or constraints for the user or multiple users who are in proximity to each other in the environment.

Note that the optimization technique may include or may use a Simplex technique or a type of gradient descent, such as a type or a variant of stochastic gradient descent. Stochastic gradient descent is an iterative technique for optimizing an objective function with suitable smoothness properties (e.g., differentiable or subdifferentiable). It can be regarded as a stochastic approximation of gradient descent optimization, because it may replace the actual gradient (calculated from the entire dataset) by an estimated gradient (which may be calculated from a randomly selected subset of the data). In high-dimensional optimization problems, this may reduce the computational burden, achieving faster iterations in exchange for a slower convergence rate. In some embodiments, the stochastic gradient descent may include: adaptive moment estimation (ADAM), batch normalization, AdaGrad (with parameter-specific learning rates), and/or stochastic gradient descent using clipped gradients.

Alternatively or additionally, in some embodiments the optimization technique may include or may use a pretrained predictive model, such as a pretrained neural network. The neural network may receive the inputs and the constraints, and may output or provide the route.

Moreover, in some embodiments, the output in the optimization technique may include a change to one or more traffic-light patterns at one or more intersections in the environment during a second time interval, which is subsequent to the time interval (such as a subsequent 1, 5, 10 or 30 minutes). This change may be based at least in part on the computed route. Thus, computer 120-1 may dynamically manage the route and/or at least one of the traffic-light patterns. This dynamic management may be interactive, so that a change to route may impact at least one of the traffic-light patterns and/or vice versa.

Computer 120-1 may provide instructions or additional information to the server that implements the traffic-mapping software and/or the instance of the traffic-mapping software executing on the cellular telephone of the driver. The instructions or the additional information may include or may specify the computed route. In response, the instance of the traffic-mapping software may display an interactive map or driving instructions for navigating the computed route.

Furthermore, computer 120-1 may provide instructions or additional information to computer 130 that include or specify the change to the one or more traffic-light patterns in the second time interval. In response, the traffic-management system implemented or associated with computer 130 may update or modify the one or more traffic-light patterns. For example, computer 130 may provide one or more instructions that implement the change in the second time interval (such as by changing the displayed traffic-light pattern of a traffic light in the environment).

Consequently, in some embodiments, the traffic-management techniques may allow concurrent or interactive determination of one or more routes of vehicles in the environment and one or more traffic-light patterns. This capability may allow dynamic and interactive determination of routes and traffic-light patterns as traffic conditions evolve in the environment. Notably, the traffic-management techniques may allow the traffic-mapping software and the traffic-management system to adapt to dynamic changes in the needs of users or drivers and to traffic conditions in the environment. Therefore, if multiple drivers attempt to navigate to the same or proximate destinations, the traffic-management techniques may not compute the same routes for these users or drivers. Instead, the traffic-management techniques may dynamically modify the computed routes and traffic-light patterns based at least in part on the dynamic plans and decisions of multiple users or drivers, as well as the predefined transportation goals of the users or drivers.

We now describe embodiments of an electronic device, which may perform at least some of the operations in the traffic-management techniques. FIG. 27 presents a block diagram illustrating an example of an electronic device 2700 in accordance with some embodiments, such as one of electronic devices 110, electronic device 112, access point 114, base station 116, one of computers 120, etc. This electronic device includes processing subsystem 2710, memory subsystem 2712, and networking subsystem 2714.

Processing subsystem 2710 includes one or more devices configured to perform computational operations. For example, processing subsystem 2710 can include one or more microprocessors, ASICs, microcontrollers, programmable-logic devices, one or more graphics process units (GPUs) and/or one or more digital signal processors (DSPs).

Memory subsystem 2712 includes one or more devices for storing data and/or instructions for processing subsystem 2710 and networking subsystem 2714. For example, memory subsystem 2712 can include dynamic random access memory (DRAM), static random access memory (SRAM), and/or other types of memory. In some embodiments, instructions for processing subsystem 2710 in memory subsystem 2712 include: one or more program modules or sets of instructions (such as program instructions 2722 or operating system 2724), which may be executed by processing subsystem 2710. Note that the one or more computer programs may constitute a computer-program mechanism. Moreover, instructions in the various modules in memory subsystem 2712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 2710.

In addition, memory subsystem 2712 can include mechanisms for controlling access to the memory. In some embodiments, memory subsystem 2712 includes a memory hierarchy that comprises one or more caches coupled to a memory in electronic device 2700. In some of these embodiments, one or more of the caches is located in processing subsystem 2710.

In some embodiments, memory subsystem 2712 is coupled to one or more high-capacity mass-storage devices (not shown). For example, memory subsystem 2712 can be coupled to a magnetic or optical drive, a solid-state drive, or another type of mass-storage device. In these embodiments, memory subsystem 2712 can be used by electronic device 2700 as fast-access storage for often-used data, while the mass-storage device is used to store less frequently used data.

Networking subsystem 2714 includes one or more devices configured to couple to and communicate on a wired and/or wireless network (i.e., to perform network operations), including: control logic 2716, an interface circuit 2718 and one or more antennas 2720 (or antenna elements) and/or input/output (I/O) port 2730. (While FIG. 27 includes one or more antennas 2720, in some embodiments electronic device 2700 includes one or more nodes, such as nodes 2708, e.g., a network node that can be coupled or connected to a network or link, or an antenna node or a pad that can be coupled to the one or more antennas 2720. Thus, electronic device 2700 may or may not include the one or more antennas 2720.) For example, networking subsystem 2714 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 2714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 2700 may use the mechanisms in networking subsystem 2714 for performing simple wireless communication between the electronic devices, e.g., transmitting advertising or beacon frames and/or scanning for advertising frames transmitted by other electronic devices as described previously.

Within electronic device 2700, processing subsystem 2710, memory subsystem 2712, and networking subsystem 2714 are coupled together using bus 2728. Bus 2728 may include an electrical, optical, and/or electro-optical connection that the subsystems can use to communicate commands and data among one another. Although only one bus 2728 is shown for clarity, different embodiments can include a different number or configuration of electrical, optical, and/or electro-optical connections among the subsystems.

In some embodiments, electronic device 2700 includes a display subsystem 2726 for displaying information on a display, which may include a display driver and the display, such as a liquid-crystal display, a multi-touch touchscreen, etc.

Electronic device 2700 can be (or can be included in) any electronic device with at least one network interface. For example, electronic device 2700 can be (or can be included in): a computer system (such as a cloud-based computer system or a distributed computer system), a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a controller, test equipment, a printer, a car, a truck, a bus, a train, a a terrestrial or airborne drone, a robot, and/or another electronic device.

Although specific components are used to describe electronic device 2700, in alternative embodiments, different components and/or subsystems may be present in electronic device 2700. For example, electronic device 2700 may include one or more additional processing subsystems, memory subsystems, networking subsystems, and/or display subsystems. Additionally, one or more of the subsystems may not be present in electronic device 2700. Moreover, in some embodiments, electronic device 2700 may include one or more additional subsystems that are not shown in FIG. 27, such as a user-interface subsystem 2732. Also, although separate subsystems are shown in FIG. 27, in some embodiments some or all of a given subsystem or component can be integrated into one or more of the other subsystems or component(s) in electronic device 2700. For example, in some embodiments program instructions 2722 are included in operating system 2724 and/or control logic 2716 is included in interface circuit 2718.

Moreover, the circuits and components in electronic device 2700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 2714 (or, more generally, of electronic device 2700). The integrated circuit may include hardware and/or software mechanisms that are used for transmitting wireless signals from electronic device 2700 and receiving signals at electronic device 2700 from other electronic devices. Aside from the mechanisms herein described, radios are generally known in the art and hence are not described in detail. In general, networking subsystem 2714 and/or the integrated circuit can include any number of radios. Note that the radios in multiple-radio embodiments function in a similar way to the described single-radio embodiments.

In some embodiments, networking subsystem 2714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the traffic-management techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the traffic-management techniques may be implemented using program instructions 2722, operating system 2724 (such as a driver for interface circuit 2718) or in firmware in interface circuit 2718. Alternatively or additionally, at least some of the operations in the traffic-management techniques may be implemented in a physical layer, such as hardware in interface circuit 2718.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the traffic-management techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with electronic devices;
a processor, coupled to the interface circuit, configured to execute program instructions; and
memory, coupled to the processor, storing the program instructions, wherein, when executed by the processor, the program instructions cause the computer system to perform operations comprising:
receiving information from a traffic-management system of an environment and second information from at least an instance of traffic-mapping software associated with the electronic device of a user, wherein the information specifies traffic-light patterns in a time interval;
computing a route, for at least a vehicle associated with the user from a current location associated with the electronic device to a destination based at least in part on the information and the second information; and
providing one or more instructions addressed to the electronic device,
wherein the one or more instructions specify the computed route.

2. The computer system of claim 1, wherein the route is based at least in part on a predefined transportation goal.

3. The computer system of claim 2, wherein the predefined transportation goal comprises: pollution associated with the vehicle when navigating the route, energy consumption associated with the vehicle when navigating the route, travel time of the vehicle when navigating the route, battery life of a battery in the vehicle, and/or an idle time of the vehicle when navigating the route.

4. The computer system of claim 1, wherein the operations comprise providing, addressed to the traffic-management system, second instructions based at least in part on the route; and
wherein the second instructions comprise a change to at least one of the traffic-light patterns in a second time interval, and the second time interval is subsequent to the time interval.

5. The computer system of claim 1, wherein a given traffic-light pattern in the traffic-light patterns comprises states of the given traffic light and associated time durations.

6. The computer system of claim 5, wherein the states comprise: a duration of a green light, a duration of a yellow light, and a duration of a red light.

7. The computer system of claim 5, wherein the given traffic-light pattern specifies when traffic is allowed to flow on particular roads in the environment.

8. The computer system of claim 1, wherein the information comprises traffic conditions in the environment; and
wherein the information is associated with different types of data sources distributed in the environment, and the environment comprises multiple intersections and roadways.

9. The computer system of claim 8, wherein the types of data sources comprise data associated with one or more of: an emergency medical system (EMS), EMS vehicles, waste-removal vehicles, municipal vehicles, public-works vehicles, vehicles associated with another municipal agency, navigation software, a mass transit system, mass-transit vehicles, trains, buses, rideshare software, rideshare vehicles, autonomous vehicles, calendar software that planned or plans a future schedule of one or more individuals or organizations, parking meters, or parking lots.

10. The computer system of claim 1, wherein the second information comprises a location of the electronic device.

11. The computer system of claim 1, wherein the operations comprise identifying an event in at least a portion of the environment based at least in part on the information and/or the second information.

12. The computer system of claim 11, wherein the operations comprise performing a remedial action based at least in part 5n the identified event.

13. The computer system of claim 12, wherein the remedial action comprises:
dynamically recomputing the route based at least in part on the identified event; or
providing an alert about the event.

14. The computer system of claim 11, wherein the identifying of the event: is based at least in part on historical traffic conditions in the environment; comprises predicting a change in a traffic condition in the environment in a subsequent time interval; comprises determining a change in the traffic conditions after the change has occurred; comparing the traffic conditions to predefined signatures of different types of events; or uses a pretrained predictive model.

15. The computer system of claim 11, wherein the event is other than a traffic event and impacts the traffic conditions.

16. The computer system of claim 1, wherein the environment comprises at least a portion of a city or a municipality.

17. The computer system of claim 1, wherein at least some of the information comprises real-time information that is received as it is acquired by a given type of source.

18. The computer system of claim 1, wherein the computed route: is based at least in part on transit times of multiple vehicles that are proximate to the vehicle in the environment; minimizes transit times of the vehicle and the vehicles to destinations; or minimize transit times of second vehicles having a higher priority than the vehicle in the environment.

19. A non-transitory computer-readable storage medium for use in conjunction with a computer system, the computer-readable storage medium storing program instructions, wherein, when executed by the computer system, the program instructions cause the computer system to perform operations comprising:
receiving information from a traffic-management system of an environment and second information from at least an instance of traffic-mapping software associated with the electronic device of a user, wherein the information specifies traffic-light patterns in a time interval;
computing a route, for at least a vehicle associated with the user from a current location associated with an electronic device to a destination based at least in part on the information and the second information; and
providing one or more instructions addressed to the electronic device, wherein the one or more instructions specify the computed route.

20. A method for managing traffic and traffic-light patterns, comprising:
by a computer system:
receiving information from a traffic-management system of an environment and second information from at least an instance of traffic-mapping software associated with the electronic device of a user, wherein the information specifies the traffic-light patterns in a time interval;
computing a route, for at least a vehicle associated with the user from a current location associated with an electronic device to a destination based at least in part on the information and the second information; and
providing one or more instructions addressed to the electronic device, wherein the one or more instructions specify the computed route.
